(19) United States
(12) Patent Application Publication
(10) Pub. No.: US 2015/0006943 A1
(43) Pub. Date: Jan. 1, 2015

(54) INFORMATION PROCESSING DEVICE, IMPROPER CONNECTION DETECTION METHOD, AND COMPUTER READABLE RECORDING MEDIUM HAVING STORED THEREIN IMPROPER CONNECTION DETECTION PROGRAM

(71) Applicant: FUJITSU LIMITED, Kwasaki-shi (JP)

(72) Inventor: Keisuke SUZUKI, Yokohama (JP)

(21) Appl. No.: 14/487,165

(22) Filed: Sep. 16, 2014

Related U.S. Application Data
(63) Continuation of application No. PCT/JP2012/057049, filed on Mar. 19, 2012.

(51) Int. Cl. G06F 1/26; G06F 11/00; G06F 11/30; G06F 1/30

(52) U.S. Cl. CPC G06F 1/263; G06F 1/30; G06F 11/004; G06F 11/3051
USPC 713/340

(57) ABSTRACT

An information processing device includes first and second power supply units that are connected to first and second power supply devices, respectively, a storage unit that stores first and second expectation values indicating states in which the first and second power supply devices are connected with the first and second power supply units, respectively, and a processor, wherein the processor acquires first connection information indicating a connection state between the first power supply unit and the first power supply device and second connection information indicating a connection state between the second power supply unit and the second power supply device, compares the expectation value with the connection information, respectively and detects an incorrect connection between the first or second power supply device and the first or second power supply unit based on a comparison result.

### CROSS-REFERENCE TO RELATED APPLICATION

This application is a continuation application of International Application PCT/JP2012/057049 filed on Mar. 19, 2012 and designated the U.S., the entire contents of which are incorporated herein by reference.

### FIELD

The embodiments discussed herein are directed to an information processing device, an improper connection detection method, and a computer-readable recording medium having stored therein an improper connection detection program.

### BACKGROUND

In an information processing device in which a continuous operation is performed such as a server, in order to increase reliability of a power supply unit that supplies power (electric power) into the device and maintainability at the time of a failure, there are cases in which a redundancy power supply unit is mounted. In this case, even when a certain power supply unit is broken, another power supply unit operates instead of the broken power supply unit, and thus the operation of the information processing device can be continued without interruptions.

Further, there are cases in which a redundancy for a power supply device serving as a power supply source is provided as illustrated in FIG. 20. FIG. 20 is a block diagram illustrating an exemplary configuration of an information processing device 100 that is connected to a plurality of power supply devices 200-1 and 200-2.

As illustrated in FIG. 20, a plurality of power supply devices, for example, the two power supply device 200-1 and 200-2 are power supply sources such as a circuit breaker, a power distribution unit (PDU) or an uninterruptible power supply (UPS), and supply the information processing device 100 with electric power. The PDU is a power strip that distributes supplied electric power to various devices such as a server in a rack or a router in a data center or the like.

The information processing device 100 illustrated in FIG. 20 includes two power supply units 300-1 and 300-2, a central processing unit (CPU) unit 500, a hard disk drive (HDD) unit 600, and a FAN unit 700. The CPU unit 500, the HDD unit 600, and the FAN unit 700 are a power supply target 400 to which electric power is supplied from the power supply unit 300-1 or the power supply unit 300-2.

In the following description, when the power supply devices 200-1 and 200-2 are not distinguished from each other, the power supply device is simply denoted by a reference numeral 200, and when the power supply units 300-1 and 300-2 are not distinguished from each other, the power supply unit is simply denoted by a reference numeral 300.

The power supply unit 300-1 is connected with one of terminals 210 (for example, outlets) of the power supply device 200-1 via a power line 200a, connected with the power supply target 400 via a power line 300a, and supplies electric power received from the power supply device 200-1 to the power supply target 400. The power supply unit 300-2 is connected with one of terminals 220 of the power supply device 200-2 via a power line 200b, connected with the power supply target 400 via a power line 300b, and supplies electric power received from the power supply device 200-2 to the power supply target 400. At least one of the power supply units 300 supplies electric power to the power supply target 400 according to whether or not electric power is supplied from the power supply device 200, an operational state of the power supply unit 300, an operational state of the power supply target 400, or the like. The power supply unit 300 is controlled by the CPU unit 500, for example, via a communication line 400a.

In the example illustrated in FIG. 20, for example, even when supply of electric power from one power supply device 200 is interrupted due to a failure or the like, the operation of the information processing device 100 can be continued without interruptions since electric power can be supplied from the other power supply device 200.

Further, as a related art, there is a technique in which electric power is supplied from a battery to a magnetic disk device when one of two AC/DC converters that are supplied with electric power from separate alternating current (AC) power supply units is broken.

Further, as another related art, there is a technique of controlling power supply between two server devices. In this technique, a first server device requests a second server device to supply electric power according to a power supply state and performs a setting so that electric power can be received from the second server device, and the second server device supplies electric power from its own power source to the first server device according to the request made from the first server device.

Furthermore, as another related art, there is a technique of detecting a failure occurred in a signal path for transceiving a data signal between a data transceiving circuit and a communication line through a power line communication device. In this technique, inspection data for failure detection is transmitted to the communication line, data is received from the communication line, the transmitted inspection data is compared with the received data, and it is determined that there is a failure in data transmission when the transmitted inspection data is not identical to the received data as a result of comparison.
Patent Literature 1: Japanese Laid-open Patent Publication No. 2003-309936
Patent Literature 2: Japanese Laid-open Patent Publication No. 2011-81716
Patent Literature 3: Japanese Laid-open Patent Publication No. 2004-320518

FIG. 21 is a block diagram illustrating an exemplary configuration of the information processing device 100 connected with one power supply device 200-1.

As illustrated in FIG. 21, even when both of the two power supply units 300 are connected to the same power supply device 200-1, the information processing device 100 normally operates as long as electric power is supplied from the power supply device 200-1. However, for example, when supply of electric power from the power supply device 200-1 is interrupted due to the occurrence of a failure or the like, none of the two power supply units 300 are not supplied with electric power, and thus the information processing device 100 is stopped.

Thus, as illustrated in FIG. 20, it is desirable that the power supply units 300-1 and 300-2 mounted in the information processing device 100 for redundancy are separately connected with the power supply devices 200-1 and 200-2.

However, when the two power supply units 300 are erroneously connected with the same power supply device 200-1 by an operator or the like at the time of installation or operation (see FIG. 21), it is hard to be aware of a connection mistake until supply of electric power from the power supply device 200-1 is stopped and thus the information processing device 100 is stopped. In order to detect an improper connection, for example, a technique of checking the redundancy of the two power supply devices 200 for the power supply unit 300 after stopping the power supply devices 200 at certain timing is considered. However, when the information processing device 100 or any other information processing device is already being operated through supply of electric power from the power supply device 200, if the power supply devices 200 are stopped, the information processing device 100 or any other information processing device is stopped, and thus it is undesirable in, for example, a server in which a continuous operation is performed.

In the above-described related arts, it is not considered to determine whether or not the redundancy power supply units are connected with different power supply devices, and it is hard to detect an incorrect connection (a wrong connection) between the power supply devices and the power supply units.

### SUMMARY

According to an aspect of the embodiments, an information processing device that is supplied with electric power from a first power supply device or a second power supply device, and includes a first power supply unit that is connected to the first power supply device, a second power supply unit that is connected to the second power supply device, a storage unit that stores a first expectation value indicating a state in which the first power supply device is connected with the first power supply unit and a second expectation value indicating a state in which the second power supply device is connected with the second power supply unit, and a processor, in which the processor acquires first connection information indicating a connection state between the first power supply unit and the first power supply device and second connection information indicating a connection state between the second power supply unit and the second power supply device, compares the first expectation value with the first connection information and compares the second expectation value with the second connection information, and detects an incorrect connection between the first power supply device and the first power supply unit or an incorrect connection between the second power supply device and the second power supply unit based on a comparison result obtained by the comparing.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an exemplary configuration of an information processing device connected to a plurality of power supply devices according to an embodiment.

FIG. 2 is a diagram for describing an example of transmission and reception of identification information according to a connection state between a power supply unit and a power supply device in the information processing device illustrated in FIG. 1.

FIG. 3 is a diagram for describing an example of transmission and reception of identification information according to a connection state between the power supply unit and the power supply device in the information processing device illustrated in FIG. 1.

FIG. 4 is a block diagram illustrating another exemplary configuration of an information processing device connected to a plurality of power supply devices according to an embodiment.

FIG. 5 is a block diagram illustrating an exemplary functional configuration of the information processing device illustrated in FIG. 4.

FIG. 6 is a diagram for describing exemplary power classification information stored in a storage unit.

FIG. 7 is a diagram for describing an exemplary expectation value table stored in the storage unit.

FIG. 8 is a diagram for describing identification information of the expectation value table illustrated in FIG. 7.

FIG. 9 is a diagram for describing an exemplary reception table stored in the storage unit.

FIG. 10 is a diagram for describing an exemplary reception table stored in the storage unit.

FIG. 11 is a diagram for describing an example of transmission and reception of identification information according to a connection state between a power supply unit and a power supply device in the information processing device illustrated in FIG. 4.

FIG. 12 is a diagram for describing an example of transmission and reception of identification information according to a connection state between a power supply unit and a power supply device in the information processing device illustrated in FIG. 4.

FIG. 13 is a diagram for describing an exemplary comparison table stored in the storage unit.

FIG. 14 is a diagram for describing exemplary power connection information stored in the storage unit.

FIG. 15 is a diagram for describing exemplary power connection information stored in the storage unit.

FIG. 16 is a flowchart for describing an exemplary operation of a power supply redundancy monitoring unit in the information processing device illustrated in FIG. 4.

FIG. 17 is a flowchart for describing an exemplary operation of the power supply redundancy monitoring unit in the information processing device illustrated in FIG. 4.

FIG. 18 is a sequence diagram for describing an exemplary operation of the information processing device when there is no incorrect connection between the power supply device and the power supply unit in the information processing device illustrated in FIG. 4.

FIG. 19 is a sequence diagram for describing an exemplary operation of the information processing device when there is an incorrect connection between the power supply device and the power supply unit in the information processing device illustrated in FIG. 4.

FIG. 20 is a block diagram illustrating an exemplary configuration of an information processing device connected with a plurality of power supply devices.

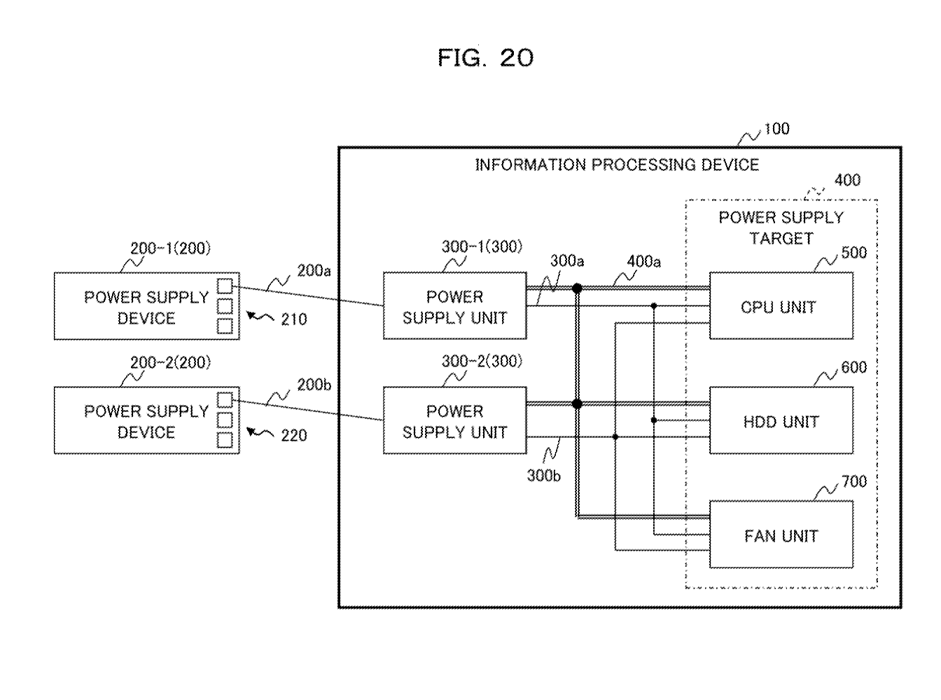

FIG. 21 is a block diagram illustrating an exemplary configuration of an information processing device connected with a single power supply device.

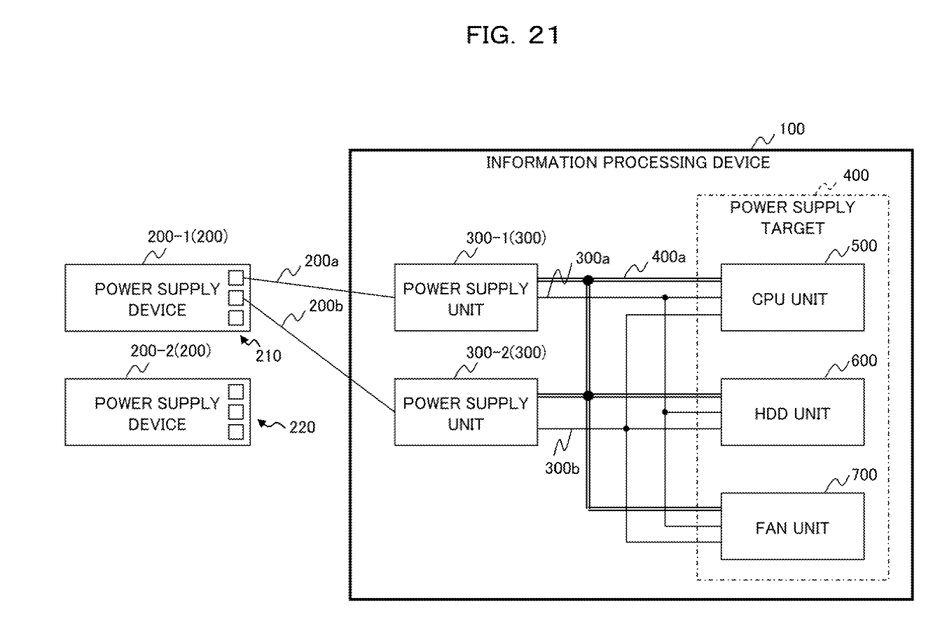

### DESCRIPTION OF EMBODIMENTS

Hereinafter, exemplary embodiments will be described with reference to the appended drawings.

### [1] Embodiment

[1-1] Description of Information Processing Device

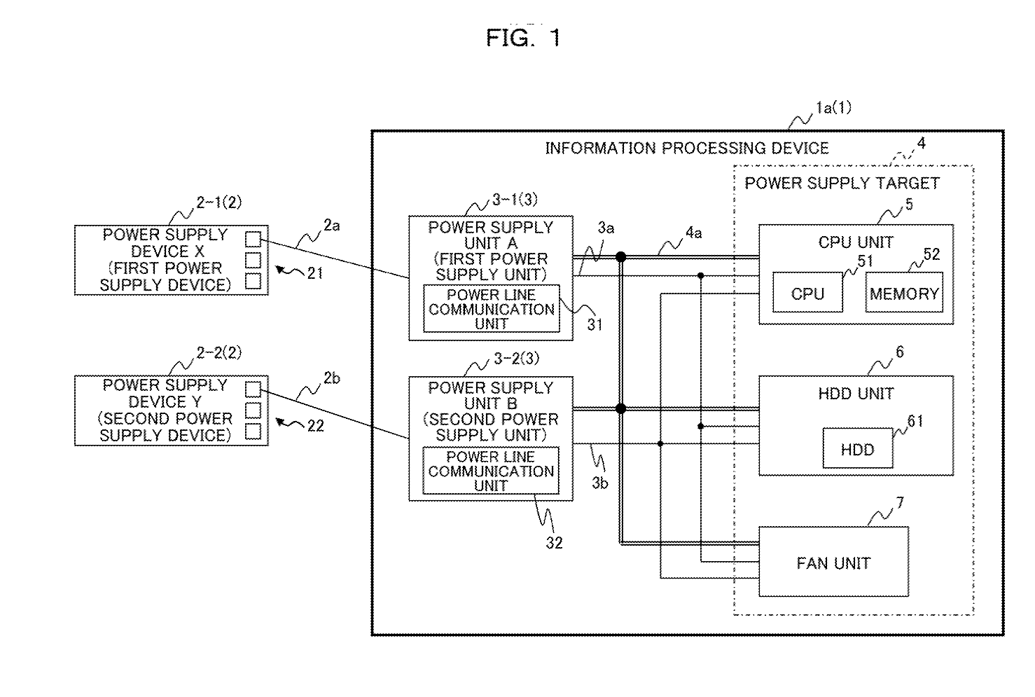

FIG. 1 is a block diagram illustrating of an exemplary configuration of an information processing device 1a(1) that is connected with power supply devices 2-1 and 2-2 according to an embodiment. As illustrated in FIG. 1, a plurality of power supply devices, for example, the two power supply devices 2-1 and 2-2 are power supply sources such as a breaker, a PDU, or an UPS, and supply AC power (electric power) to the information processing device 1a. In the following description, when the power supply devices 2-1 and 2-2 are not distinguished from each other, the power supply device is simply denoted by a reference numeral 2.

The power supply device (first power supply device) 2-1 includes at least one terminal 21, and the power supply device (second power supply device) 2-2 includes at least one terminal 22. For example, the terminals 21 and 22 are connecting portions to which power lines 2a and 2b such as outlets are attachable.

The information processing device 1a illustrated in FIG. 1 is a device that is supplied with electric power from the power supply device 2-1 or the power supply device 2-2. In the example illustrated in FIG. 1, for example, even when supply of electric power from one power supply device 2 is interrupted due to a failure or the like, the operation of the information processing device 1a can be continued without stopping the operation since electric power can be supplied from the other power supply device 2.

The information processing device 1a includes a plurality of power supply units (for example, two power supply units 3-1 and 3-2), a CPU unit 5, an HDD unit 6, and a FAN unit 7. In the following description, when the power supply unit 3-1 and the power supply unit 3-2 are not distinguished from each other, the power supply unit is simply denoted by a reference numeral 3. The CPU unit 5, the HDD unit 6, and the PAN unit 7 are a power supply target 4 to which electric power is supplied from the power supply unit 3-1 or the power supply unit 3-2.

The power supply unit (first power supply unit) 3-1 is connected to one of terminals 21 of the power supply device 2-1 via the power line 2a, connected with the power supply target 4 via a power line 3a, and supplies electric power received from the power supply device 2-1 to the power supply target 4. The power supply unit (second power supply unit) 3-2 is connected to one of terminals 22 of the power supply device 2-2 via the power line 2b, connected with the power supply target 4 via a power line 3b, and supplies electric power received from the power supply device 2-2 to the power supply target 4.

The power supply unit 3-1 includes a power line communication unit (communication unit) 31, and the power supply unit 3-2 includes a power line communication unit (communication unit) 32. Each of the power line communication units 31 and 32 has a power line communication (PLC) function. The PLC is a technique of transmitting AC power of a power line with a high-frequency signal (information) superimposed thereon, and uses a half-duplex scheme as a communication scheme. In the example illustrated in FIG. 1, a signal transmitted from the power supply unit 3 through the PLC is transmitted to the power supply device 2 via the power line 2a or the power line 2b, and then received by the terminal 21 or the terminal 22 connected to the power line 2a or the power line 2b in the power supply device 2. Further, when another power line is connected to another terminal 21 or another terminal 22 of the power supply device 2, the received signal is output from the power supply device 2 via another terminal 21 or another terminal 22.

The power line communication unit 31 transmits information (first information) to the power supply device 2-1 via the power line 2a, and receives information (the first information) transmitted from the power supply device 2-1 via the power line 2a. The power line communication unit 32 transmits information (second information) to the power supply device 2-2 via the power line 2b, and receives information (the second information) transmitted from the power supply device 2-2 via the power line 2b.

The CPU unit 5 includes a CPU 51 and a memory 52. The CPU 51 is an example of a processor that performs various kinds of control or calculations, and executes a program stored in the memory 52 or a read only memory (ROM) (not illustrated) to implement various kinds of functions in the information processing device 1a. In the present embodiment, the CPU 51 executes an improper connection detection program and functions as a power supply redundancy monitoring unit 10 which will be described later. The memory 52 is a storage device that temporarily stores various kinds of data and programs, and when the CPU 51 executes the program, data or a program is temporarily stored, developed, and used. As the memory 52, a volatile memory such as a random access memory (RAM) is used.

The HDD unit 6 includes an HDD 61. The HDD 61 is a magnetic disk device that stores various kinds of data and programs. The HDD unit 6 may include various kinds of storage devices such as semiconductor drive devices including solid state drives (SSDs) instead of, or together with the HDD 61. The FAN unit 7 is a cooling device that cools each unit of the information processing device 1a, and includes, for example, at least one fan (not illustrated).

The power supply unit 3, the CPU unit 5, the HDD unit 6, and the FAN unit 7 are connected to communicate with one another via a communication line 4a. Communication between the respective units is controlled by an input output (IO) controller (not illustrated). For example, an inter-integrated circuit (I2C) bus is used between the CPU unit 5 and the power supply unit 3 as the communication line 4a, and communication is controlled by an I2C controller (not illustrated). At least one of the power supply units 3 supplies electric power to the power supply target 4 according to whether or not electric power is supplied from the power supply device 2, the operational state of the power supply unit 3, the operational state of the power supply target 4, or the like. The power supply unit 3 is controlled by the CPU unit 5, for example, via the communication line 4a.

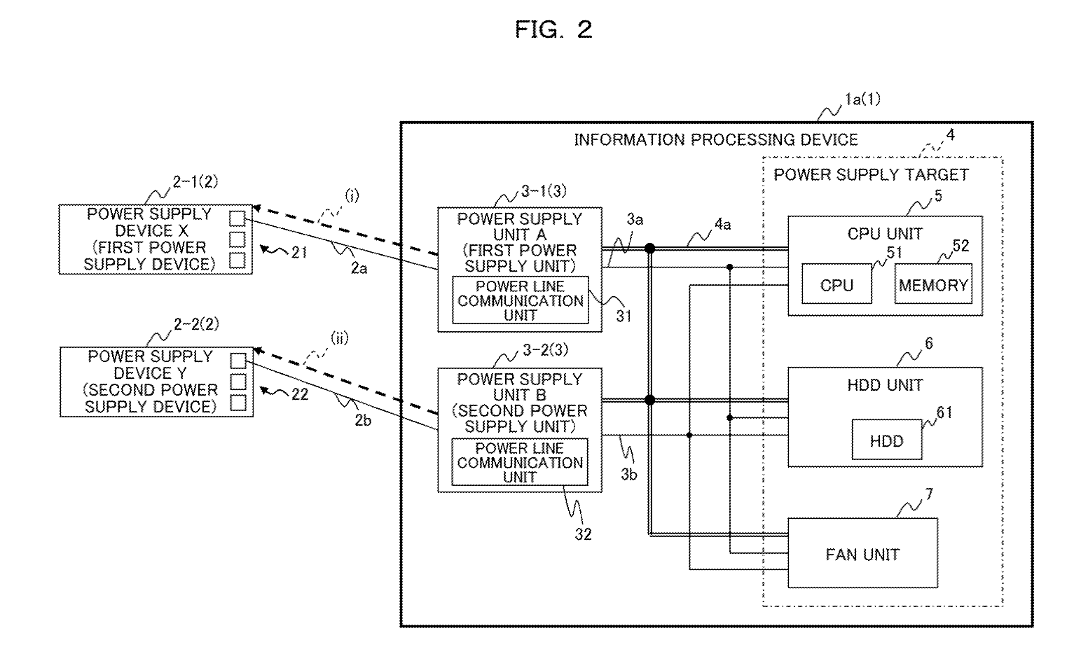

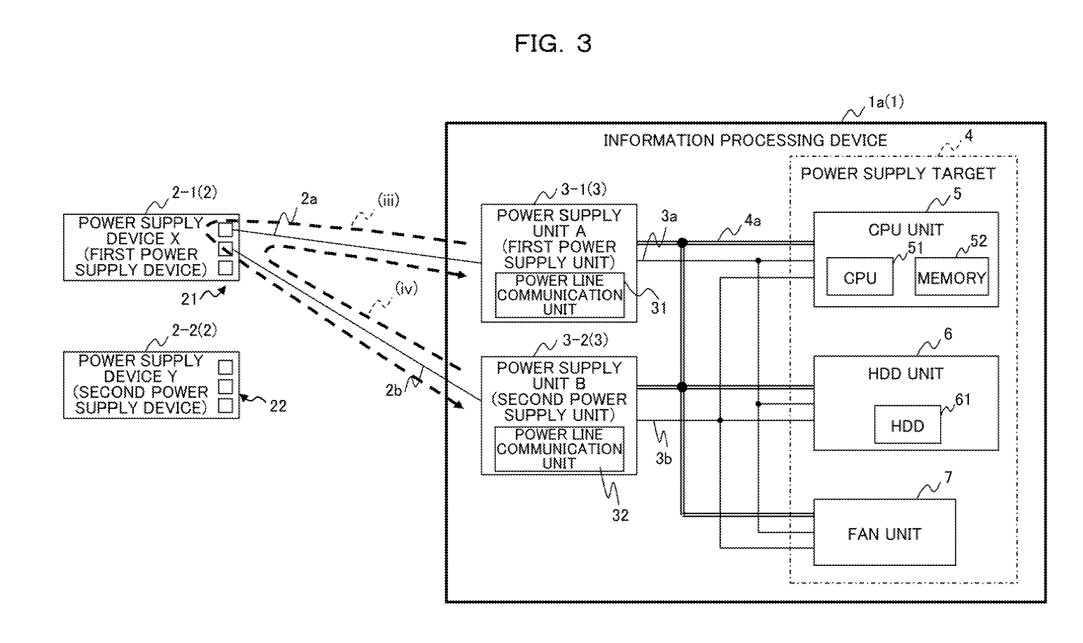

Here, the information processing device 1a according to the present embodiment monitors the redundancy (redundant connectivity) of the power supply unit 3, that is, the redundancy of the power supply unit 3 for the power supply device 2, and detects an incorrect connection between the power supply device 2 and the power supply unit 3. Hereinafter, an exemplary technique of monitoring the redundancy of the power supply unit 3 through the information processing device 1a according to the present embodiment will be described with reference to FIGS. 2 and 3. FIGS. 2 and 3 are diagrams for describing exemplary transmission and reception of identification information according to a connection state between the power supply unit 3 and the power supply device 2 in the information processing device 1a illustrated in FIG. 1.

The information processing device 1a according to the present embodiment transmits or receives identification information of each power supply unit 3 to the power supply device 2 from each power supply unit 3 via the power line 2a or the power line 2b through the PLC. Then, the information processing device 1a compares an expectation value of the identification information received by each power supply unit 3 with an actual reception result of the identification information by each power supply unit 3, and checks the connection state between the power supply unit 3 and the power supply device 2.

For example, in the information processing device 1a illustrated in FIG. 1, the power supply unit 3-1 is connected with the power supply device 2-1, the power supply unit 3-2 is connected with the power supply device 2-2, and each power supply unit 3 is supplied with electric power from an independent supply source. In this case, the identification information of the power supply unit 3-1 transmitted from the power line communication unit 31 is received by the terminal 21 connected to the power line 2a in the power supply device 2-1, but since no power line is connected to the other terminals 21, transmission from the power supply device 2-1 is not performed. Similarly, the identification information of the power supply unit 3-2 transmitted from the power line communication unit 32 is received by the terminal 22 connected to the power line 2b in the power supply device 2-2, but since no power line is connected to the other terminals 22, transmission from the power supply device 2-2 is not performed. In other words, in the information processing device 1a illustrated in FIG. 1, the expectation value of the identification information received by each power supply unit 3 is “no received” in both the power supply unit 3-1 and the power supply unit 3-2.

As illustrated in FIG. 2, in the information processing device 1a illustrated in FIG. 1, when there is no incorrect connection between the power supply device 2 and the power supply unit 3, the identification information transmitted from the power supply unit 3-1 is received by the power supply device 2-1 via the power line 2a as indicated by an arrow (i) in FIG. 2. Further, the identification information transmitted from the power supply unit 3-2 is received by the power supply device 2-2 via the power line 2b as indicated by an arrow (ii) in FIG. 2. Further, each power supply unit 3 does not perform reception of the identification information transmitted through the terminal 21 or the terminal 22 of the power supply device 2. In other words, the reception result is “not received” in both of the power supply unit 3-1 and the power supply unit 3-2.

Meanwhile, as illustrated in FIG. 3, in the information processing device 1a illustrated in FIG. 1, when there is an incorrect connection between the power supply device 2 and the power supply unit 3, for example, the power supply unit 3-2 is considered to be connected with the terminal 21 of the power supply device 2-1 other than the power supply device 2-2. In this case, the identification information transmitted from the power supply unit 3-1 via the power line 2a passes through the terminal 21 of the power supply device 2-1, and then is received by the power supply unit 3-2 via the power line 2b as indicated by an arrow (iii) in FIG. 3. Further, the identification information transmitted from the power supply unit 3-2 via the power line 2b passes through the terminal 21 of the power supply device 2-1, and then is received by the power supply unit 3-1 via the power line 2a as indicated by an arrow (iv) in FIG. 3. In other words, the power supply unit 3-1 receives the identification information of the power supply unit 3-2, and the power supply unit 3-2 receives the identification information of the power supply unit 3-1.

Then, the information processing device 1a compares the expectation values of the identification information received by the power supply units 3 with the actual reception results of the identification information by the power supply units 3, and checks the connection state between the power supply unit 3 and the power supply device 2. For example, since all of the expectation values and the actual reception results in the power supply units 3 are “not received”, the information processing device 1a illustrated in FIG. 2 determines that there is no incorrect connection between the power supply device 2 and the power supply unit 3. Meanwhile, since all the expectation values in the power supply units 3 are “not received” but the actual reception results are “received” because the identification information of the power supply unit 3 of the other party has been received, the information processing device 1a illustrated in FIG. 3 determines that there is an incorrect connection between the power supply device 2 and the power supply unit 3.

As described above, the information processing device 1a according to the present embodiment transmits and receives the identification information that passes through the terminals 21 and 22 that are outlets of the power supply device 2 through the power supply units 3 via the power lines 2a and 2b. Then, the information processing device 1a compares the expectation values of the identification information received by the power supply units 3 with the identification information actually received by the power supply units 3, and checks the connection state between the power supply unit 3 and the power supply device 2.

[1-2] Configuration of Information Processing Device

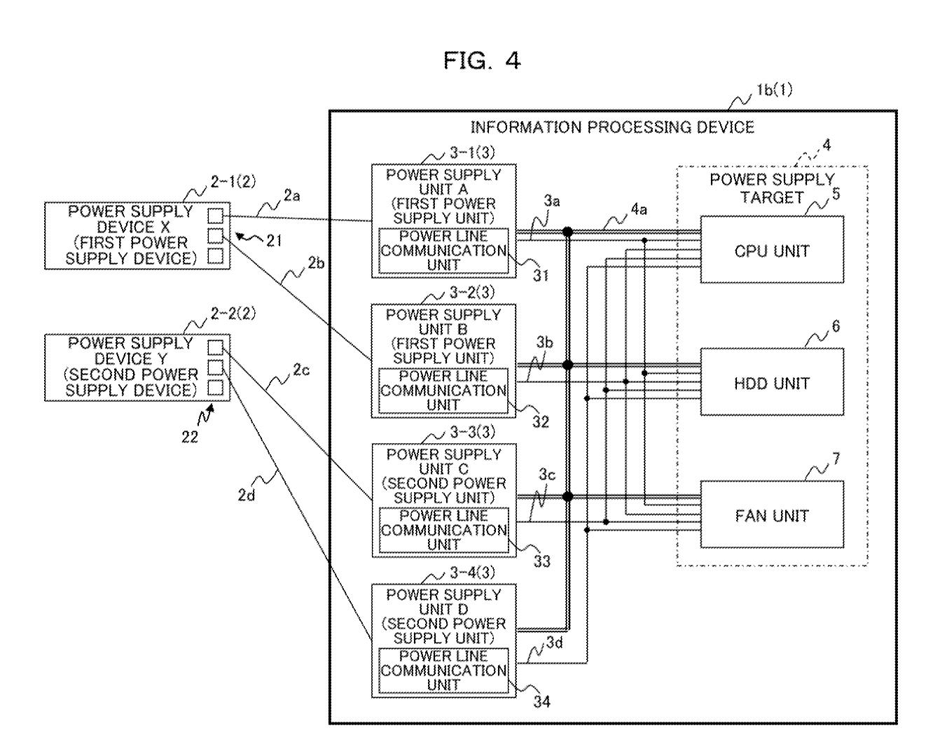

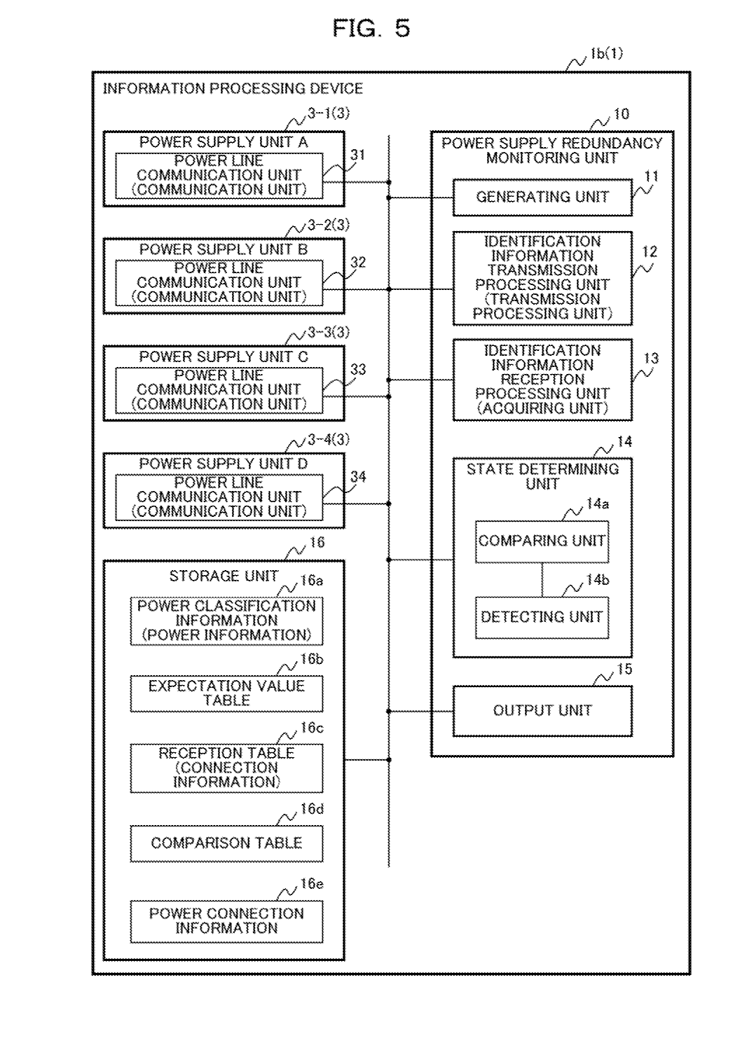

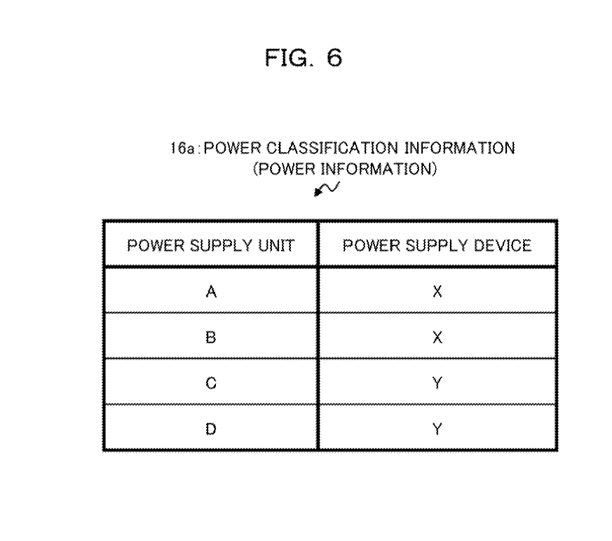

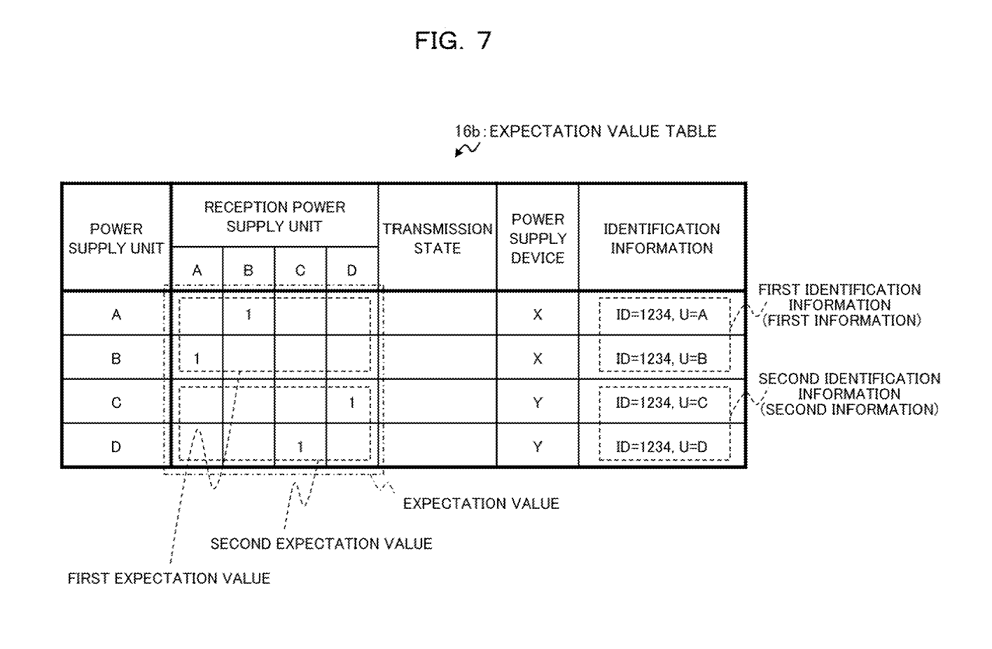

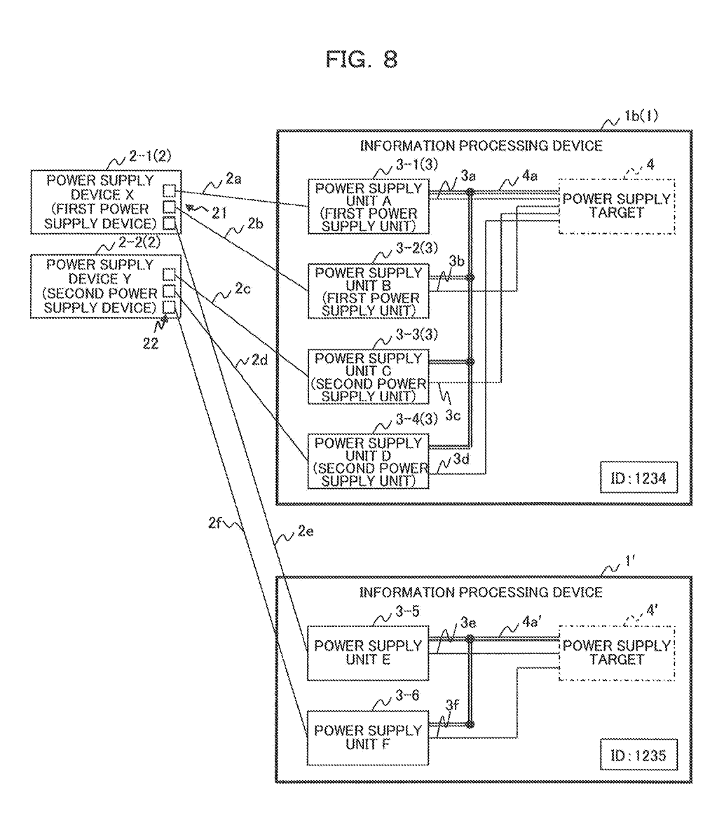

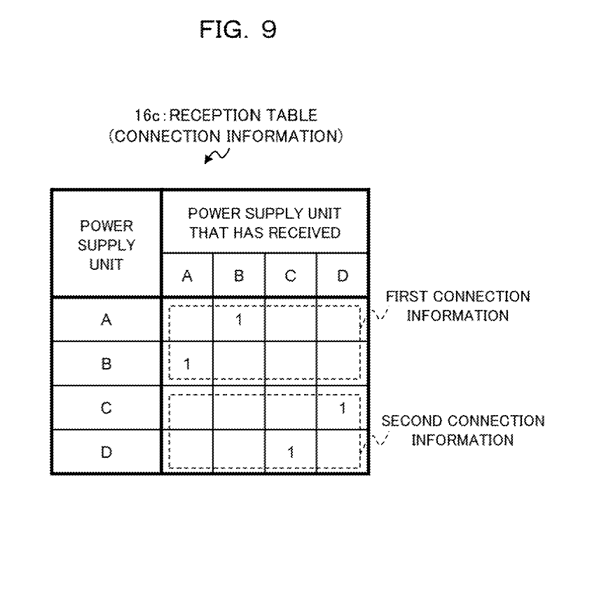

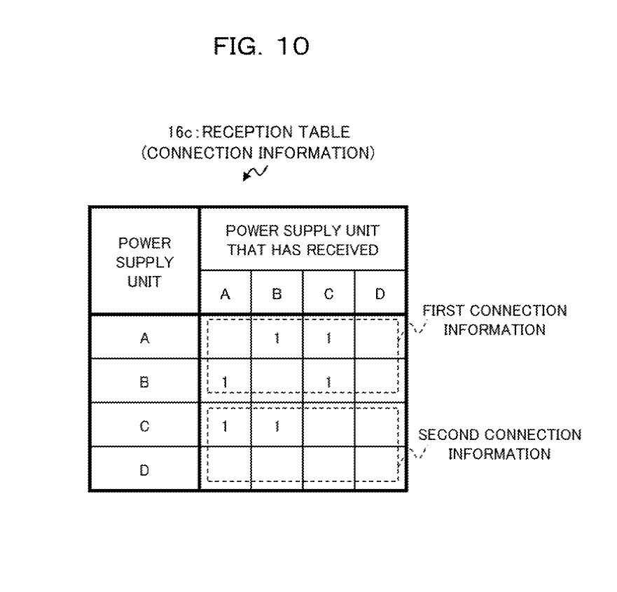

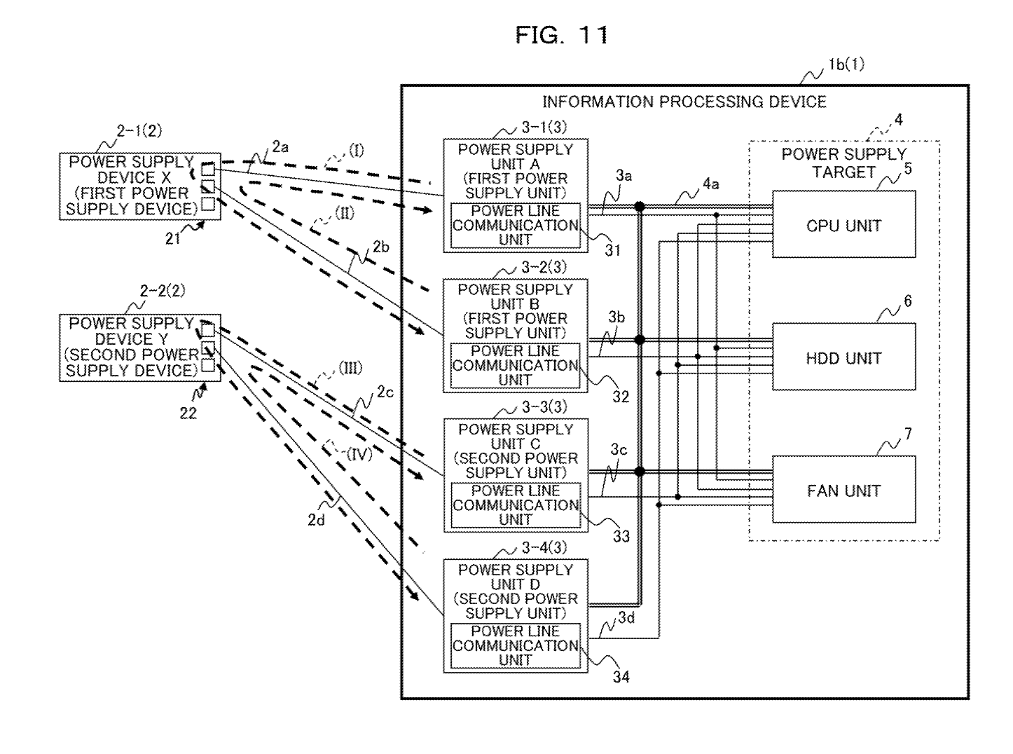

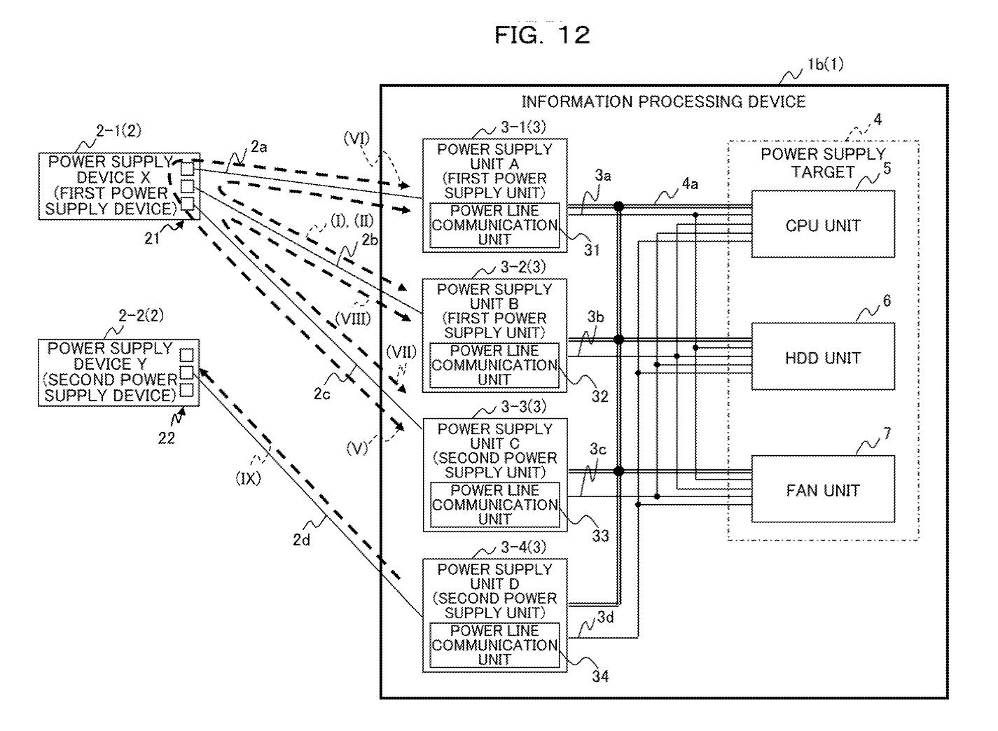

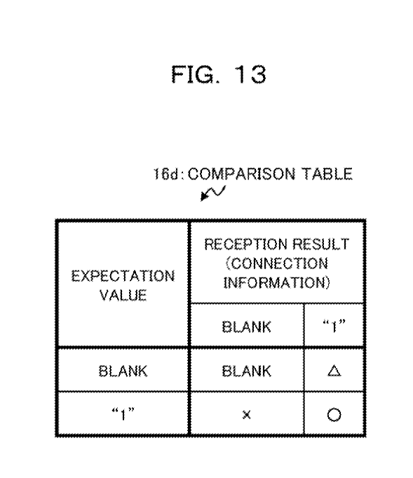

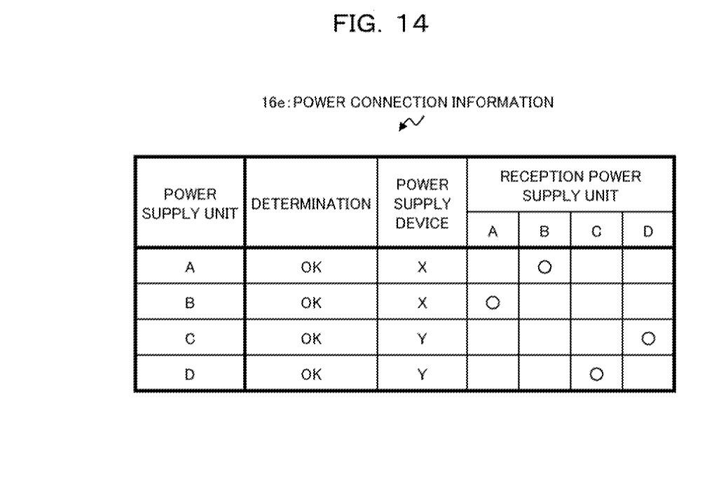

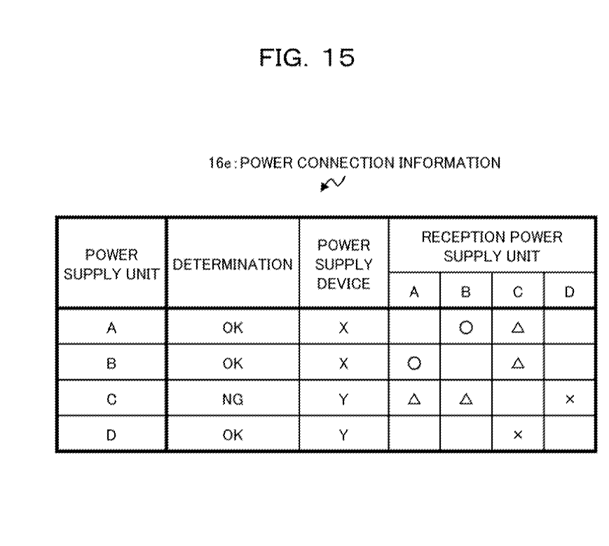

Next, a configuration of an information processing device 1 will be described with reference to an information processing device 1b(1) illustrated in FIGS. 4 and 5 instead of the information processing device 1a(1) illustrated in FIG. 1. FIG. 4 is a block diagram illustrating an exemplary configuration of the information processing device 1b that is connected with power supply devices 2-1 and 2-2 according to an embodiment, and FIG. 5 is a block diagram illustrating an exemplary functional configuration of the information processing device 1b illustrated in FIG. 4. FIG. 6, FIG. 7, and FIG. 13 are diagrams for describing examples of power classification information 16a, an expectation value table 16b, and a comparison table 16d stored in a storage unit 16. FIGS. 9 and 10 are diagram for describing examples of a reception table 16c stored in the storage unit 16, and FIG. 14 and FIG. 15 are diagrams for describing examples of power connection information 16e stored in the storage unit 16. FIG. 8 is a diagram for describing the identification information of the expectation value table 16b illustrated in FIG. 7. FIG. 11 and FIG. 12 are diagrams for describing examples of transmission and reception of the identification information according to the connection state between the power supply unit 3 and the power supply device 2 in the information processing device 1b illustrated in FIG. 4. In FIG. 4, the same reference numerals as in FIG. 1 denote the same or almost the same components as those in FIG. 1, and thus a description thereof will not be repeated. In FIG. 4, FIG. 11, and FIG. 12, for simplification of the drawings, illustration of the CPU 51, the memory 52, and the HDD 61 is omitted.

The information processing device 1b(1) illustrated in FIG. 4 includes power supply units 3-3 and 3-4 in addition to the configuration of the information processing device 1a illustrated in FIG. 1. In the following description, when the power supply units 3-1 to 3-4 are not distinguished from one another, the power supply unit is simply denoted by a reference numeral 3. Hereinafter, for convenience of description, the power supply device 2-1 and the power supply device 2-2 are also referred to as a “power supply device X” and a “power supply device Y”, the power supply units 3-1 to 3-4 are also referred to as a “power supply unit A” to a “power supply unit D”.

The power supply unit (the first power supply unit) 3-1 and the power supply unit (the first power supply unit) 3-2 are connected with the terminal 21 of the power supply device 2-1 via the power line 2a and the power line 2b, connected with the power supply target 4 via the power line 3a and the power line 3b, and supply electric power received from the power supply device 2-1 to the power supply target 4. The power supply unit (the second power supply unit) 3-3 and the power supply unit (the second power supply unit) 3-4 connected with the terminal 22 of the power supply device 2-2 via a power line 2c and a power line 2d, connected with the power supply target 4 via a power line 3c and a power line 3d, and supply electric power received from the power supply device 2-2 to the power supply target 4.

The power supply unit 3-3 includes a power line communication unit 33, and the power supply unit 3-4 includes a power line communication unit 34. The power line communication unit (communication unit) 33 and the power line communication unit (communication unit) 34 have a PLC function, similarly to the power line communication units 31 and 32.

The power line communication unit (communication unit) 31 and the power line communication unit (communication unit) 32 transmit information (the first information) to the power supply device 2-1 via the power line 2a and the power line 2b, and receive information (the first information) transmitted from the power supply device 2-1 via the power line 2a and the power line 2b. Further, the power line communication unit 33 and the power line communication unit 34 transmit information (the second information) to the power supply device 2-2 via the power line 2c and the power line 2d, and receive information (the second information) transmitted from the power supply device 2-2 via the power line 2c and the power line 2d.

As illustrated in FIG. 5, the information processing device 1b functions as the power supply redundancy monitoring unit 10 that sets and monitors the redundancy (redundant connectivity) of the power supply unit 3, that is, the redundancy of the power supply unit 3 for the power supply device 2. The information processing device 1b includes the storage unit 16. The function as the power supply redundancy monitoring unit 10 is implemented when the CPU 51 executes the improper connection detection program as described above. As the storage unit 16, a readable/writable storage device such as the memory 52 or the HDD 61 may be used. The power supply redundancy monitoring unit 10 and the storage unit 16 illustrated in FIG. 5 can be similarly equipped in the information processing device 1a illustrated in FIG. 1.

[1-2-1] Storage Unit

The storage unit 16 stores the power classification information 16a, the expectation value table 16b, the reception table 16c, the comparison table 16d, and the power connection information 16e.

The power classification information (power information) 16a is a table representing the power supply device 2 connected to each power supply unit 3 of the information processing device 1b as illustrated in FIG. 6, and is set and updated by the operator, the CPU 51, or the like when the information processing device 1b is initially set or changed in configuration. For example, in the power classification information 16a, the power supply device X is set for the power supply units A and B, and the power supply device Y is set for the power supply units C and D as illustrated in FIGS. 4 and 6.

The expectation value table 16b is information including a first expectation value indicating a state in which the power supply device X is connected with the power supply units A and B and a second expectation value indicating a state in which the power supply device Y is connected with the power supply units C and D. The expectation value table 16b includes “reception power supply unit”, “transmission state”, “power supply device”, and “identification information” for each power supply unit 3 as illustrated in FIG. 7. The expectation value table 16b is generated based on the power classification information 16a through a generating unit 11 which will be described later.

The “reception power supply unit” (the first expectation value and the second expectation value) is an expectation value representing the power supply units A to D that receive the identification information through the power supply device X or the power supply device Y when the identification information is transmitted from the power supply units A to D to the power supply device X or the power supply device Y. In the “reception power supply unit”, a value (for example, “I”) indicating “received” is set to a crossing point between each of the “power supply units” A to D that transmits the identification information and each of the “reception power supply units” A to D that can receive the identification information. Further, in the “reception power supply unit”, a value (for example, “blank”) indicating “not received” is set to a crossing point between each of the “power supply units” A to D that transmits the identification information and each of the “reception power supply units” A to D that hardly receive the identification information. The “transmission state” is information representing the transmission state of the identification information, and set by an identification information transmission processing unit 12 which will be described later. The “power supply device” is information representing the power supply device 2 connected with each of the power supply units A to D.

The “identification information” is information representing each of the power supply units A to D, and includes a device number (ID) of the information processing device 1b and a power supply unit number (U) set to the power classification information 16a. The device number is a device-specific number such as a serial number that is uniquely allocated to each device, and the power supply unit number is a number identifying the power supply unit 3 such as “A” to “D” of the power supply units 3. Further, as illustrated in FIG. 7, the “identification information” is represented by a device number added following an identifier “ID=”, a delimiter such as a comma (“,”), and a power supply unit number added following an identifier “U=”.

In the expectation value table 16b, ranges of the “reception power supply unit” and the “identification information” of the power supply units A and B connected with the power supply device X are referred to as a “first expectation value” and a “first the identification information (first information)”, respectively. Further, in the expectation value table 16b, ranges of the “reception power supply unit” and the “identification information” of the power supply units C and D connected with the power supply device Y are referred to as a “second expectation value” and a “second identification information (second information)”, respectively.

The reception table (connection information) 16c is information including first connection information representing the connection state between the power supply units A and B and the power supply device X and second connection information representing the connection state between the power supply units C and D and the power supply device Y. Specifically, the reception table 16c is information representing the power supply unit 3 that has actually received the “identification information” transmitted from the power supply unit 3 through the power supply device 2 for each power supply unit 3, and set by an identification information reception processing unit 13 which will be described later as illustrated in FIGS. 9 and 10.

A value (for example, “blank”) representing “not received” is set to a region of “power supply unit that has received” of the reception table 16c by default. Further, in the reception table 16c, a value (for example, “1”) representing “received” is set to a crossing point between each of the “power supply units” A to D identified by the received identification information and each of the “power supply unit A that has received” to “power supply unit D that has received” that have received the identification information. In other words, when “1” is set to a crossing point between the “power supply unit” and the “power supply unit that has received”, it means that communication of information (identification information) by the PLC has been performed between the “power supply unit” and the “power supply unit that has received”. FIG. 9 illustrates the reception table 16c when the power supply unit 3 in the information processing device 1b and the power supply device 2 are in the connection state illustrated in FIG. 11 (see FIG. 4), and FIG. 10 illustrates the reception table 16c when the power supply unit 3 and the power supply device 2 are in the connection state illustrated in FIG. 12.

In the reception table 16c, a range of the “power supply unit that has received” of the power supply units A and B indicated to be connected with the power supply device X in the expectation value table 16b is referred to as “first connection information”, and a range of the “power supply unit that has received” of the power supply units C and D indicated to be connected with the power supply device Y is referred to as “second connection information”.

The comparison table 16d is a table used for a comparison process of comparing the expectation value table 16b with the reception table 16c through a comparing unit 14a which will be described later, and is information used to determine the connection state of the power supply unit 3, as illustrated in FIG. 13. In the comparison table 16d, a comparison result is set according to the expectation value set to the “reception power supply unit” of the expectation value table 16b and a value of the reception result (connection information) set to the “power supply unit that has received” of the reception table 16c. For example, when both the expectation value and the reception result are “blank”, the comparison result is “blank”, and when the expectation value is “blank” but the reception result is “1”, the comparison result is “Δ”. Further, when the expectation value is “1” but the reception result is “blank”, the comparison result is “x”, and when both the expectation value and the reception result are “1”, the comparison result is “∘”. The values of “blank”, “x”, “Δ”, and “∘” in the comparison table 16d are set using 2-bit data such as “00”, “01”, “10”, and “11”.

The power connection information 16e is a table to which the determination result on the redundancy of the power supply unit 3 by the power supply redundancy monitoring unit 10 is set as illustrated in FIGS. 14 and 15, and is set by a detecting unit 14b which will be described later. The power connection information 16e includes “determination” representing whether or not the power supply unit 3 is connected with the power supply device 2 represented in the power classification information 16a, the “power supply device” represented in the power classification information 16a, and “reception power supply unit” set based on the comparison table 16d, for each power supply unit 3. FIG. 14 illustrates the power connection information 16e when the power supply unit 3 in the information processing device 1b and the power supply device 2 are in the connection state illustrated in FIG. 11 (see FIG. 4), and FIG. 15 illustrates the power connection information 16e when the power supply unit 3 and the power supply device 2 are in the connection state illustrated in FIG. 12.

[1-2-2] Power Supply Redundancy Monitoring Unit

Referring back to FIG. 5, the power supply redundancy monitoring unit 10 includes the generating unit 11, the identification information transmission processing unit 12, the identification information reception processing unit 13, a state determining unit 14, and an output unit 15.

The generating unit 11 generates the first expectation value and the second expectation value based on the power classification information 16a (see FIG. 6) representing the connection relation between the power supply units 3-1 to 3-4 and the power supply devices 2-1 and 2-2, and stores the first expectation value and the second expectation value in the storage unit 16. Specifically, the generating unit 11 acquires the power classification information 16a from the storage unit 16, and generates the expectation value table 16b based on information of the acquired “power supply unit” and information of the “power supply device”. Further, the generating unit 11 recognizes the power supply device X or the power supply device Y connected with the power supply units A to D, and determines the power supply units A to D connected with the same power supply device X or the same power supply device Y.

Further, the generating unit 11 generates the first expectation value by setting “1” to the crossing point between the “power supply unit” A and the “reception power supply unit” B connected with the same power supply device X and the crossing point between the “power supply unit” B and the “reception power supply unit” A. Further, the generating unit 11 generates the second expectation value by setting “1” to the crossing point between the “power supply unit” C and the “reception power supply unit” D connected with the same power supply device Y and the crossing point between the “power supply unit” D and the “reception power supply unit” C. Furthermore, the generating unit 11 acquires the device number of the information processing device 1b and the power supply unit number of the power supply unit 3, generates the first identification information (the first information) for the power supply device X and the second identification information (the second information) for the power supply device Y, and sets the generated information as the “identification information” of the expectation value table 16b.

The identification information transmission processing unit (transmission processing unit) 12 causes the power supply units A to D to transmit the identification information to the connected power supply device X or the power supply device Y based on the expectation value table 16b. Specifically, the identification information transmission processing unit 12 gives an identification information transmission instruction to transmit “ID=1234, U=A” to “ID=1234, U=D” that are the identification information of the power supply unit 3 to each of the power line communication units 31 to 34 of the power supply units A to D based on the expectation value table 16b (see FIG. 7). The power line communication units 31 and 32 that have received this instruction transmits the identification information (the first identification information, the first information) to the power supply device X connected via the power lines 2a and 2b via the power lines 2a and 2b through the PLC, respectively. The power line communication units 33 and 34 that have received this instruction transmits the identification information (the second identification information, the second information) to the power supply device Y connected via the power lines 2c and 2d via the power lines 2c and 2d through the PLC, respectively.

The identification information transmitted from the power line communication units 31 to 34 through the identification information transmission processing unit 12 passes through the terminals 21 and 22 of the power supply device 2, respectively, and then is received in all the power line communication units 31 to 34 connected to the same power supply device 2. Since the PLC is performed using the half-duplex scheme, the power supply unit 3 hardly receives the identification information from any other power supply unit 3 during transmission of the identification information. Thus, the identification information transmission processing unit 12 gives the identification information transmission instruction to the power supply units A to D at certain intervals, for example, in the order of the power supply units A to D set by the expectation value table 16b.

Further, the identification information transmission processing unit 12 checks the transmittable state of the power line communication units 31 to 34 of the power supply units A to D, for example, via the I2C bus. Then, when it is determined to be the transmittable state, the identification information transmission processing unit 12 transmits the identification information of the power supply units A to D that perform transmission to the corresponding power line communication units 31 to 34 extracted from the expectation value table 16b. However, when it is determined to be the untransmittable state, the identification information transmission processing unit 12 sets “disable” to the “transmission state” of the corresponding power supply unit 3 of the expectation value table 16b, and sets “off” (for example, “blank”) to all the expectation values of columns and rows of the power supply unit 3. The transmittable state is, for example, a state in which the power line communication units 31 to 34 (the power supply unit 3) are connected with the power supply device 2 via the power lines 2a to 2d, so that communication can be performed by the PLC. Further, the untransmittable state is, for example, a state in which the power line communication units 31 to 34 (the power supply unit 3) are not supplied with electric power or a state in which the power line communication units 31 to 34 (the power supply unit 3) do not operate due to an accident such as a failure.

The identification information reception processing unit (acquiring unit) 13 acquires the first connection information and the second connection information through the power supply units A to D based on the first identification information or the second identification information received through the power supply device X or the power supply device Y. Specifically, the identification information reception processing unit 13 receives the identification information that has passed through the terminals 21 and 22 of the power supply device 2, has been received by the power line communication units 31 to 34, and then has transmitted from the power line communication units 31 to 34. The identification information reception processing unit 13 generates the reception table 16c illustrated in FIG. 9 or FIG. 10. Then, the identification information reception processing unit 13 compares the device number included in the received identification information with the device number of its own information processing device 1b, and sets “1” to the crossing point between the “power supply unit” of the power supply unit number included in the received identification information and the “power supply unit that has received” the identification information in the reception table 16c when the two device numbers are identical to each other.

For example, when the information processing device 1b whose device number (ID) is “1234” and another information processing device 1′ whose device number (ID) is “1235” are connected with the power supply device 2 and supplied with electric power as in a configuration illustrated in FIG. 8, “1234” is set to the “identification information” of the expectation value table 16b in the information processing device 1b as the device number. At this time, when the device number of the received identification information is “1235” indicating another information processing device 1′, the identification information reception processing unit 13 discards the identification information since the identification information is unnecessary for generation of the reception table 16c. A power supply unit 3-5 illustrated in FIG. 8 is connected with the terminal 21 of the power supply device 2-1 via a power line 2e, and a power supply unit 3-6 is connected with the terminal 22 of the power supply device 2-2 via a power line 2f. The power supply units 3-5 and 3-6 supply electric power to a power supply target 4′ via a power line 4a′.

Here, a process of generating the reception table 16c illustrated in FIGS. 9 and 10 according to the connection state between the power supply unit 3 and the power supply device 2 in the information processing device 1b through the identification information reception processing unit 13 will be described with reference to FIGS. 11 and 12. In the following description, the crossing points of the “power supply unit” and the “power supply unit that has received” in the reception table 16c are indicated by [(number (character) A to D of power supply units), (number (character) of A to D of power supply units that have received)].

The identification information reception processing unit 13 generates the first connection information ([A,A] to [B,D]) for the power supply device X and the second connection information ([C,A] to [D,D]) for the power supply device Y based on the identification information received by the power line communication units 31 and 32 as illustrated in FIGS. 9 and 10.

First, in the information processing device 1b illustrated in FIG. 4, there is considered to be no incorrect connection between the power supply device 2 and the power supply unit 3 as illustrated in FIG. 11. In this case, the identification information transmitted from the power supply unit A via the power line 2a passes through the terminal 21 of the power supply device X as indicated by an arrow (I) in FIG. 11 and is then received by the power supply unit B via the power line 2b (“1” is set to [A,B] in FIG. 9). Further, the identification information transmitted from the power supply unit B via the power line 2b passes through the terminal 21 of the power supply device X as indicated by an arrow (II) in FIG. 11 and is then received by the power supply unit A via the power line 2a (“1” is set to [B,A] in FIG. 9). Similarly, the identification information transmitted from the power supply unit C via the power line 2c passes through the terminal 22 of the power supply device Y as indicated by an arrow (III) in FIG. 11 and is then received by the power supply unit D via the power line 2d (“1” is set to [C,D] in FIG. 9). Further, the identification information transmitted from the power supply unit D via the power line 2d passes through the terminal 22 of the power supply device Y as indicated by an arrow (IV) in FIG. 11 and is then received by the power supply unit C via the power line 2c (“1” is set to [D,C] in FIG. 9).

As described above, in the case of the connection state illustrated in FIG. 11, the identification information reception processing unit 13 generates the reception table 16c illustrated in FIG. 9 through the above-described setting process.

Meanwhile, when there is an incorrect connection between the power supply device 2 and the power supply unit 3 in the information processing device 1b illustrated in FIG. 4 as illustrated in FIG. 12, for example, the case is considered that the power supply unit C is connected with the terminal 21 of the power supply device 2-1 other than the power supply device 2-2. In this case, the identification information is transmitted and received between the power supply unit A and the power supply unit B as indicated by the arrows (I) and (II) in FIG. 11 (“1” is set to [A,B] and [B,A] in FIG. 10). In addition, the identification information transmitted from the power supply unit A via the power line 2a passes through the terminal 21 of the power supply device X as indicated by an arrow (V) in FIG. 12, and is then received by the power supply unit C via the power line 2c (“1” is set to [A,C] in FIG. 10). Further, the identification information transmitted from the power supply unit B via the power line 2b passes through the terminal 21 of the power supply device X as indicated by an arrow (VII) in FIG. 12, and is then received by the power supply unit C via the power line 2c (“1” is set to [B,C] in FIG. 10).

Further, the identification information transmitted from the power supply unit C via the power line 2c passes through the terminal 21 of the power supply device X as indicated by an arrow (VI) in FIG. 12, and is then received by the power supply unit A via the power line 2a (“1” is set to [C,A] in FIG. 10) as illustrated in FIG. 12. Similarly, the identification information transmitted from the power supply unit C via the power line 2c passes through the terminal 21 of the power supply device X as indicated by an arrow (VIII) in FIG. 12, and is then received by the power supply unit B via the power line 2b (“1” is set to [C,B] in FIG. 10).

Further, the identification information transmitted from the power supply unit D via the power line 2d is received by the power supply device Y via the power line 2d as indicated by an arrow (IX) in FIG. 12, but none of the power supply units 3 performs reception of the identification information ([D,A] to [D,C] in FIG. 10 are “blank”).

As described above, in the case of the connection state illustrated in FIG. 12, the identification information reception processing unit 13 generates the reception table 16c illustrated in FIG. 10 through the above-described setting process.

The state determining unit 14 determines the connection state between the power supply unit 3 and the power supply device 2 based on the expectation value table 16b and the reception table 16c, and generates the power connection information. The state determining unit 14 includes the comparing unit 14a and the detecting unit 14b.

The comparing unit 14a compares the first expectation value with the first connection information, and compares the second expectation value with the second connection information. Specifically, the comparing unit 14a generates the power connection information 16e illustrated in FIG. 14 or 15, compares the expectation value table 16b with the reception table 16c based on the comparison table 16d, and sets the comparison result to the power connection information 16e.

More specifically, the comparing unit 14a sequentially compares the values (the expectation values) of the crossing points between the “power supply unit” and the “reception power supply unit” in the expectation value table 16b illustrated in FIG. 7 with the values (connection information) of the crossing points between the “power supply unit” and the “power supply unit that has received” in the reception table 16c illustrated in FIG. 9 or 10. At this time, the comparing unit 14a acquires the comparison result corresponding to the relation between the expectation value and the connection information from the comparison table 16d. Then, the comparing unit 14a sets the acquired comparison result to the crossing point between the “power supply unit” and the “reception power supply unit” in the power connection information 16e. The comparing unit 14a skips the comparison process on the power supply unit 3 in which “disable” is set to “determination” in the expectation value table 16b.

For example, the case in which there is no incorrect connection between the power supply device 2 and the power supply unit 3 in the information processing device 1b illustrated in FIG. 4 as illustrated in FIG. 11, that is, the case in which the reception table 16c illustrated in FIG. 9 is generated will be described. In this case, the comparing unit 14a compares the expectation value table 16b illustrated in FIG. 7 with the reception table 16c illustrated in FIG. 9, for example, in the order of [A,A], . . . , [A,D], [B,A], . . . , and [D,D] in any one of the tables. When both the “expectation value” and the “connection information” are “blank” as in [A,A] and [A,C], the comparing unit 14a acquires “blank” that is the comparison result when the “expectation value” and the “reception result (connection information)” are “blank” from the comparison table 16d, and sets “blank” to the corresponding region of the power connection information 16e illustrated in FIG. 14. Further, when both the “expectation value” and the “connection information” are “1” as in [A,B], [B A], [C D], and [D C], the comparing unit 14a acquires the comparison result “∘” from the comparison table 16d, and sets “∘” to the corresponding region of the power connection information 16e illustrated in FIG. 14.

Next, the case in which there is an incorrect connection between the power supply device 2 and the power supply unit 3 in the information processing device 1b illustrated in FIG. 4 as illustrated in FIG. 12, that is, the case in which the reception table 16c illustrated in FIG. 10 is generated will be described. In this case, the comparing unit 14a sets the comparison result “blank” or “∘” to the point at which the “expectation value” is identical to the “connection information”, similarly to that of FIG. 14. In addition, the comparing unit 14a sets “x” or “Δ” representing “mismatch”, that is, an improper connection state to the point at which the “expectation value” is different from the “connection information” as the connection state of the power supply units. For example, when the “expectation value” is “0” but the “connection information” is “1” as in [A,C], [B,C], [C,A], and [C,B], the comparing unit 14a acquires the comparison result “Δ” from the comparison table 16d, and sets the comparison result “Δ” to the corresponding region of the power connection information 16e illustrated in FIG. 15. Further, when the “expectation value” is “1” but the “connection information” is “0” as in [C,D] and [D,C], the comparing unit 14a acquires the comparison result “x” from the comparison table 16d, and sets the comparison result “x” to the corresponding region of the power connection information 16e.

As described above, the comparing unit 14a compares with the expectation value table 16b with the reception table 16c, and generates the power connection information 16e based on the comparison result as the connection state between the power supply unit 3 and the power supply device 2.

The detecting unit 14b detects an incorrect connection between the power supply device X and the power supply units A and B or detects an incorrect connection between the power supply device Y and the power supply units C and D, based on the comparison result obtained by the comparing unit 14a. Specifically, the detecting unit 14b decides the power supply unit 3 having the most “Δ” or “x” representing the improper connection state with reference to the power connection information 16e. Then, the detecting unit 14b sets “NG” (for example, 1-bit data “1”) to “determination” of the detected power supply unit 3 in the power connection information 16e, and sets “OK” (for example, 1-bit data “0”) to “determination” of the other power supply units 3. When there are two or more power supply units 3 having the most “Δ” or “x” representing the improper connection state, the detecting unit 14b sets “NG” to “determination” of the two or more power supply unit 3.

The output unit 15 causes the power connection information 16e generated by the state determining unit 14 to be stored in a recording medium such as the HDD 61 as a result of monitoring (determining) the redundant connectivity of the power supply unit 3 by the power supply redundancy monitoring unit 10. Further, when “NG” is set in the power connection information 16e, the output unit 15 gives a notification to urge the operator or the like to check the connection state between the power supply device 2 and the power supply unit 3. Further, the output unit 15 may give a notification to the operator or the like when the monitoring (determining) is completed regardless whether or not “NG” is set.

The notifications may be output or displayed through an output device such as a monitor or a printer (not illustrated) equipped in the information processing device 1b, and may be given to another information processing device via a local area network (LAN) adaptor (not illustrated) equipped in the information processing device 1b. Further, the notifications may include content of the power connection information 16e or information specifying the power connection information 16e, and may include only information indicating that “NG” is set in the power connection information 16e or information indicating that the monitoring (determining) has been completed.

In order to monitor the connection state between the power supply unit 3 and the power supply device 2, the power supply redundancy monitoring unit 10 may execute the above-described processes performed by the generating unit 11, the identification information transmission processing unit 12, the identification information reception processing unit 13, the state determining unit 14, and the output unit 15, for example, at intervals of certain periods of time (periodically).

As described above, in the information processing device 1 (the information processing device 1a, the information processing device 1b) according to the present embodiment, the power supply redundancy monitoring unit 10 generates a connection matrix between the power supply units 3 (the power line communication units 31 to 34) involving the power supply device 2 as the expectation value table 16b. Further, the power supply redundancy monitoring unit 10 causes the inspection data (the identification information) to be exchanged between the power supply units 3, and generates the reception table 16c of the connection matrix between the power supply units 3 involving the power supply device 2 based on the reception data. Thus, the power supply redundancy monitoring unit 10 can detect whether or not a plurality of power supply devices 2 are connected to the power supply units 3 (the power line 2a to the power line 2d) of the information processing device 1 to have a redundancy configuration.

Accordingly, the power supply redundancy monitoring unit 10 compares the expectation value table 16b with the reception table 16c, and thus can specify the power supply unit 3 having a transmission path different from the expectation value due to an improper connection (connection mistake). In other words, according to the power supply redundancy monitoring unit 10, it is possible to reliably detect an incorrect connection between the power supply device 2 and the power supply unit 3 of the information processing device 1 (the information processing device 1a and the information processing device 1b).

[1-3] Exemplary Operation of Information Processing Device

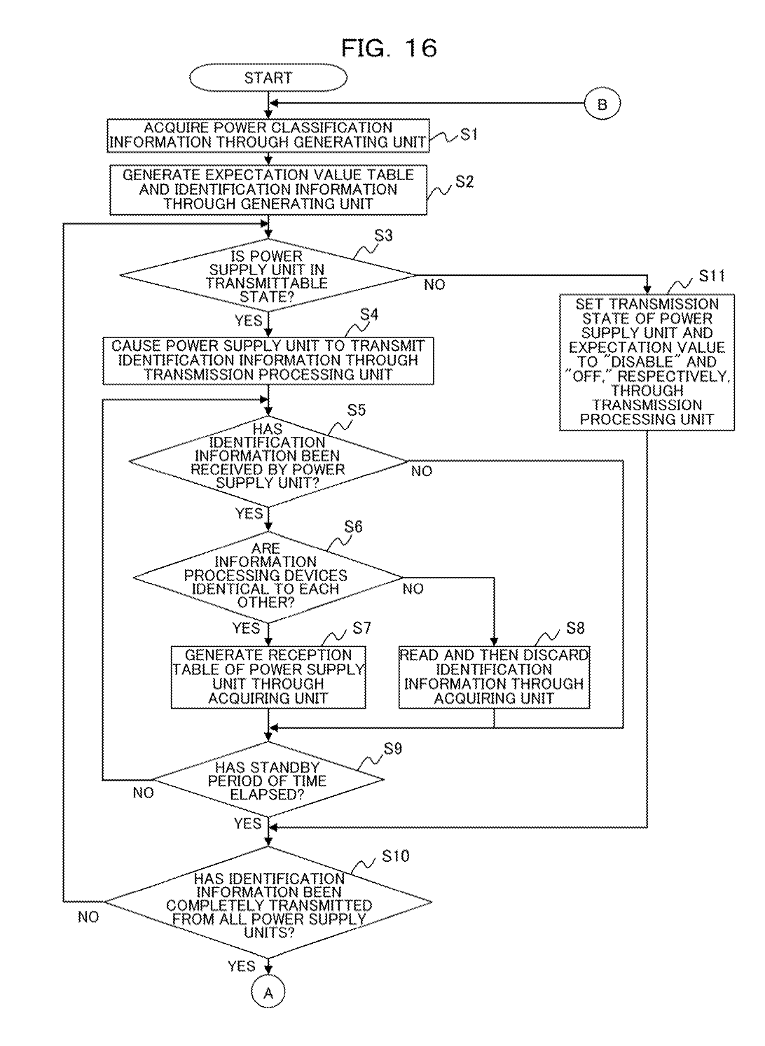

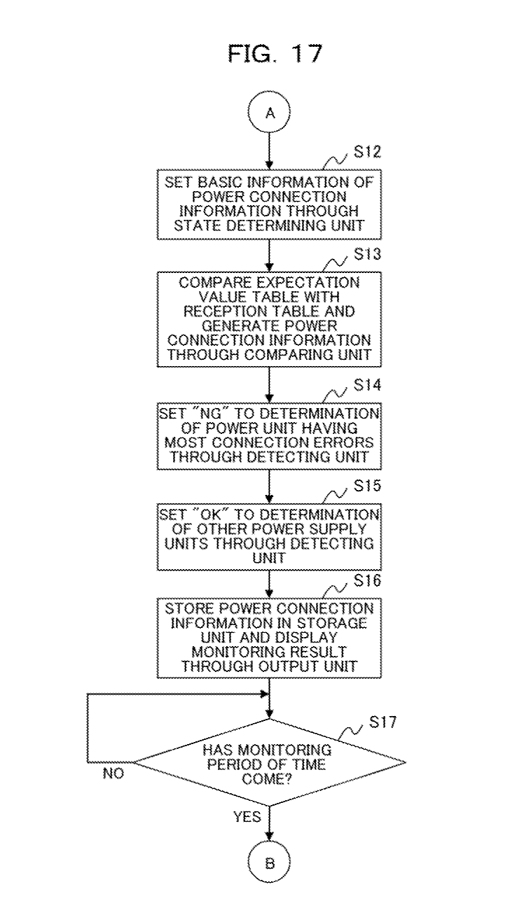

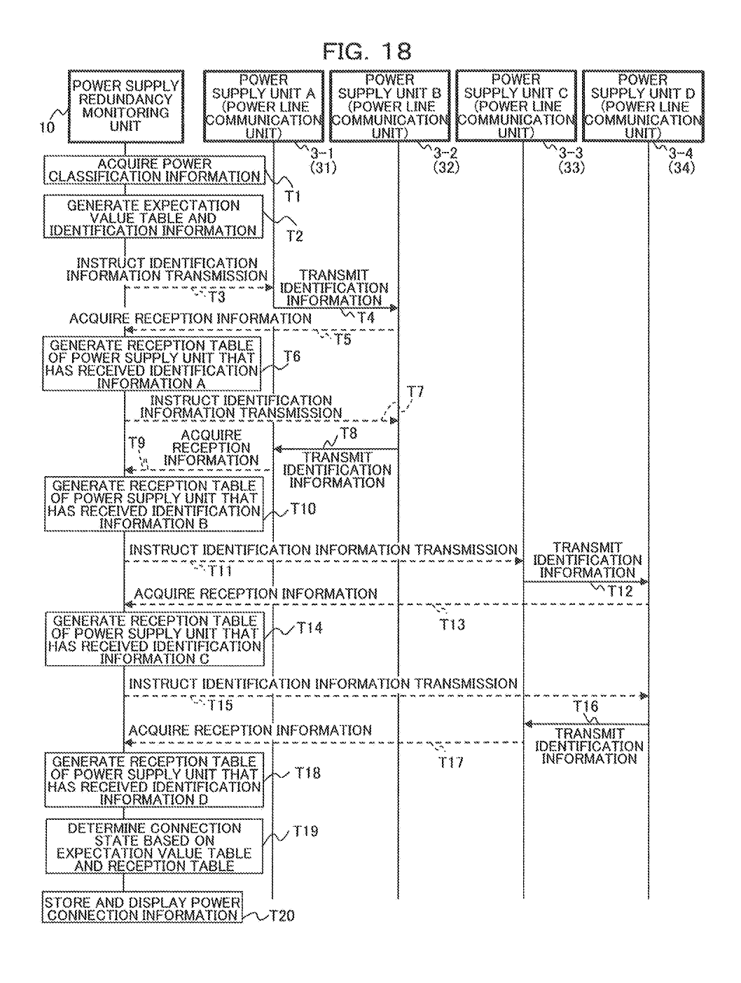

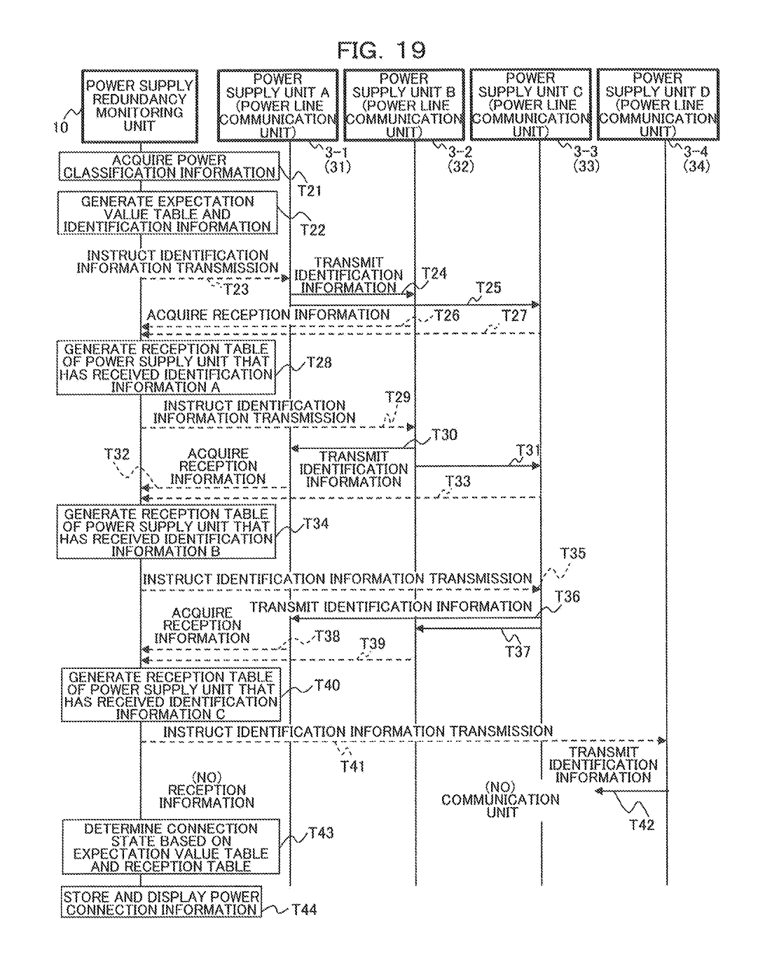

Next, an exemplary operation of the power supply redundancy monitoring unit 10 in the information processing device 1b having the above configuration will be described with reference to FIGS. 16 to 19. FIGS. 16 and 17 are flowcharts for describing an exemplary operation of the power supply redundancy monitoring unit 10 in the information processing device 1b illustrated in FIG. 4, and FIGS. 18 and 19 are sequence diagrams for describing an exemplary operation of the information processing device 1b in a case where there is no incorrect connection and the other case where there is incorrect operation between the power supply device 2 and the power supply unit 3 in the information processing device 1b illustrated in FIG. 4.

First, an exemplary operation of the power supply redundancy monitoring unit 10 will be described with reference to FIGS. 16 and 17.

When the power supply redundancy monitoring unit 10 starts monitoring, the generating unit 11 acquires the power classification information 16a from the storage unit 16 (step S1). Then, the generating unit 11 generates the expectation value table 16b including the expectation values of the power supply units 3 based on the power classification information 16a, generates the identification information, and sets the identification information to the expectation value table 16b (step S2).

Then, the identification information transmission processing unit 12 selects, for example, the power supply unit 3 initially set according to the expectation value table 16b, and determines, via the I2C bus or the like, whether or not it is the transmittable state (step S3). When it is determined to be the transmittable state (Yes route in step S3), the identification information transmission processing unit 12 instructs the power line communication unit 31 to 34 of the selected power supply unit 3 to transmit the identification information (step S4). In step S4, the identification information transmission processing unit 12 starts counting during a standby period of time of a certain period of time.

Then, the identification information reception processing unit 13 determines whether or not the identification information has been received by the power line communication units 31 to 34 of the power supply unit 3 (step S5). When the identification information is determined to have been received (Yes route in step S5), the identification information reception processing unit 13 determines whether or not the device ID included in the identification information is identical to the device ID of the information processing device 1b (step S6). When the device ID included in the identification information is determined to be identical to the device ID of the information processing device 1b (Yes route in step S6), the identification information reception processing unit 13 generates (updates) the reception table 16c in which the power supply unit 3 that has transmitted the identification information is associated with the power supply unit 3 that has received the identification information (in which “1” is set to the crossing point) (step S7), and the process proceeds to step S9. Meanwhile, when the device ID included in the identification information is determined to be not identical to the device ID of the information processing device 1b (No route in step S6), the identification information reception processing unit 13 discards the received identification information (step S8), and the process proceeds to step S9.

In step S9, the identification information transmission processing unit 12 determines whether or not the standby period of time has elapsed, and the process proceeds to step S5 in order to continue the reception process performed by the identification information reception processing unit 13 when the standby period of time is determined to have not elapsed (No route in step S9). Meanwhile, when the standby period of time is determined to have elapsed (Yes route in step S9), the process proceeds to step S10. Further, when the selected power supply unit 3 is determined to be not in the transmittable state in step S3 (No route in step S3), the identification information transmission processing unit 12 sets “disable” to the “transmission state” of the selected power supply unit 3 in the expectation value table 16b, and set “blank” (off) to the expectation value (step S11), and the process proceeds to step S10.

In step S10, the identification information transmission processing unit 12 determines whether or not transmission of the identification information from all the power supply units 3 has been completed, and selects a next power supply unit 3 through the identification information transmission processing unit 12 when the transmission of the identification information from any of the power supply units 3 is determined to have not been completed (No route in step S10), and the process proceeds to step S3. Meanwhile, when the transmission of the identification information from any of the power supply units 3 is determined to have been completed (Yes route in step S10), the process proceeds to step S12 in FIG. 17.

In step S12 in FIG. 17, the state determining unit 14 (the comparing unit 14a) generates the power connection information 16e, and sets basic information, that is, the “power supply unit” and the “power supply device” (see FIGS. 14 and 15). At this time, the state determining unit 14 checks the transmission state of the expectation value table 16b, and sets “disable” to “determination” of the power connection information 16e of the corresponding power supply unit 3 when there is the power supply unit 3 to which “disable” (see step S11 in FIG. 16) is set. Then, the comparing unit 14a compares the expectation value table 16b with the reception table 16c based on the comparison table 16d to determine the connection state of the power supply unit 3, and the comparison result is set to the power connection information 16e (step S13).

Then, the detecting unit 14b decides the power supply unit 3 having the most “mismatches”, that is, the most improper connections based on the power connection information 16e, and sets “NG” to “determination” of the decided power supply unit 3 in the power connection information 16e (step S14). Further, the detecting unit 14b sets “OK” to “determination” of the other power supply units 3 in the power connection information 16e (step S15). Then, the output unit 15 causes the power connection information 16e to be stored, causes the monitoring result to be displayed on, for example, a screen of an output device or the like (step S16), and the power supply redundancy monitoring unit 10 is on standby until a next monitoring period of time (step S17 and No route in step S17). When the monitoring period of time comes (Yes route in step S17), the power supply redundancy monitoring unit 10 proceeds to step S1 in FIG. 16 in order to perform next monitoring.

As described above, the power supply redundancy monitoring unit 10 performs two-way communication between the power supply device 2 and the power supply unit 3 through the identification information transmission process (steps S1 to S4 and steps S9 to S11) and the reception process (steps S5 to S8). Further, the power supply redundancy monitoring unit 10 performs the determination process of determining and detecting an improper connection based on the actually communicated information (steps S12 to S16). Furthermore, in order to periodically monitor the connection state between the power supply unit 3 and the power supply device 2, the monitoring process is performed such that the process of steps S1 to S16 is performed at intervals of certain periods of time (step S17).

Next, an exemplary operation of the information processing device 1b when there is no incorrect connection between the power supply device 2 and the power supply unit 3 in the information processing device 1b illustrated in FIG. 4 (FIG. 18; see FIG. 11) and an exemplary operation of the information processing device 1b when there is an incorrect connection between the power supply device 2 and the power supply unit 3 (FIG. 19; see FIG. 12) will be described with reference to FIGS. 18 and 19.

When there is no incorrect connection, the power supply redundancy monitoring unit 10 acquires the power classification information 16a through the generating unit 11 as illustrated in FIG. 18 (step T1). Then, the generating unit 11 generates the expectation value table 16b, generates the identification information of each power supply unit 3, and stores the generated information in the expectation value table 16b (step T2).

Then, in the power supply redundancy monitoring unit 10, the identification information transmission processing unit 12 gives the identification information transmission instruction, for example, to the power supply unit A according to the expectation value table 16b (step T3). In the power supply unit A, the power line communication unit 31 transmits the identification information (hereinafter, referred to as “identification information A”) according to the identification information transmission instruction (step T4). The identification information A passes through the power line 2a, the terminal 21 of the power supply device X, and then the power line 2b, and is received by the power line communication unit 32 of the power supply unit B. The power supply unit B that has received the identification information A notifies the power supply redundancy monitoring unit 10 of the reception information (step T5), and the identification information reception processing unit 13 of the power supply redundancy monitoring unit 10 generates the reception table 16c of the power supply unit B that has received the identification information A (step T6).

Then, the identification information transmission processing unit 12 gives the identification information transmission instruction to, for example, the power supply unit B according to the expectation value table 16b (step T7). In the power supply unit B, the power line communication unit 32 transmits identification information B according to the identification information transmission instruction (step T8). The identification information B passes through the power line 2b, the terminal 21 of the power supply device X, and then the power line 2a, and is received by the power line communication unit 31 of the power supply unit A. The power supply unit A that has received the identification information B notifies the power supply redundancy monitoring unit 10 of the reception information (step T9), and the identification information reception processing unit 13 of the power supply redundancy monitoring unit 10 generates (updates) the reception table 16c of the power supply unit A that has received the identification information B (step T10).

Further, the identification information transmission processing unit 12 gives the identification information transmission instruction to, for example, the power supply unit C according to the expectation value table 16b (step T11). In the power supply unit C, the power line communication unit 33 transmits identification information C according to the identification information transmission instruction (step T12). The identification information C passes through the power line 2c, the terminal 22 of the power supply device Y, and then the power line 2d, and is received by the power line communication unit 34 of the power supply unit D. The power supply unit D that has received the identification information C notifies the power supply redundancy monitoring unit 10 of the reception information (step T13), and the identification information reception processing unit 13 of the power supply redundancy monitoring unit 10 generates (updates) the reception table 16c of the power supply unit D that has received the identification information C (step T14).

Then, the identification information transmission processing unit 12 gives the identification information transmission instruction to, for example, the power supply unit D according to the expectation value table 16b (step T15). In the power supply unit D, the power line communication unit 34 transmits identification information D according to the identification information transmission instruction (step T16). The identification information D passes through the power line 2d, the terminal 22 of the power supply device Y, and then the power line 2c, and is received by the power line communication unit 33 of the power supply unit C. The power supply unit C that has received the identification information D notifies the power supply redundancy monitoring unit 10 of the reception information (step T17), and the identification information reception processing unit 13 of the power supply redundancy monitoring unit 10 generates (updates) the reception table 16c of the power supply unit C that has received the identification information D (step T18).

When transmission of the identification information by all the power supply units 3 is completed, the state determining unit 14 (the comparing unit 14a and the detecting unit 14b) determines the connection state between the power supply unit 3 and the power supply device 2 based on the expectation value table 16b and the reception table 16c, and generates the power connection information 16e (step T19). Then, the output unit 15 causes the power connection information 16e to be stored and displayed on an output device or the like (step T20), and then the process of the power supply redundancy monitoring unit 10 is completed.

Next, when there is an incorrect connection, in the power supply redundancy monitoring unit 10, the generating unit 11 acquires the power classification information 16a as illustrated in FIG. 19 (step T21). Then, the generating unit 11 generates the expectation value table 16b, generates the identification information of each the power supply unit 3, and sets the generated information to the expectation value table 16b (step T22).

Then, in the power supply redundancy monitoring unit 10, the identification information transmission processing unit 12 gives the identification information transmission instruction, for example, to the power supply unit A according to the expectation value table 16b (step T23). In the power supply unit A, the power line communication unit 31 transmits the identification information A according to the identification information transmission instruction. The identification information A passes through the power line 2a, the terminal 21 of the power supply device X, and then the power line 2b, and is received by the power line communication unit 32 of the power supply unit B (step T24), and passes through the power line 2a, the terminal 21 of the power supply device X, and then the power line 2c, and is received by the power line communication unit 33 of the power supply unit C (step T25). The power supply units B and C that have received the identification information A notifies the power supply redundancy monitoring unit 10 of the reception information (steps T26 and T27), and the identification information reception processing unit 13 of the power supply redundancy monitoring unit 10 generates the reception table 16c of the power supply units B and C that have received the identification information A (step T28).

Then, the identification information transmission processing unit 12 gives the identification information transmission instruction to, for example, the power supply unit B according to the expectation value table 16b (step T29). In the power supply unit B, the power line communication unit 32 transmits identification information B according to the identification information transmission instruction. The identification information B passes through the power line 2b, the terminal 21 of the power supply device X, and then the power line 2a, and is received by the power line communication unit 31 of the power supply unit A (step T30), and passes through the power line 2b, the terminal 21 of the power supply device X, and then the power line 2c, and is received by the power line communication unit 33 of the power supply unit C (step T31). The power supply units A and C that have received the identification information B notifies the power supply redundancy monitoring unit 10 of the reception information (steps T32 and T33), and the identification information reception processing unit 13 of the power supply redundancy monitoring unit 10 generates (updates) the reception table 16c of the power supply units A and C that have received the identification information B (step T34).

Further, the identification information transmission processing unit 12 gives the identification information transmission instruction to, for example, the power supply unit C according to the expectation value table 16b (step T35). In the power supply unit C, the power line communication unit 33 transmits identification information C according to the identification information transmission instruction. The identification information C passes through the power line 2c, the terminal 21 of the power supply device X, and then the power line 2a, and is received by the power line communication unit 31 of the power supply unit A (step T36), and passes through the power line 2c, the terminal 21 of the power supply device X, and then the power line 2b, and is received by the power line communication unit 32 of the power supply unit B (step T37). The power supply units A and B that have received the identification information C notifies the power supply redundancy monitoring unit 10 of the reception information (steps T38 and T39), and the identification information reception processing unit 13 of the power supply redundancy monitoring unit 10 generates (updates) the reception table 16c of the power supply units A and B that have received the identification information C (step T40).

Then, the identification information transmission processing unit 12 gives the identification information transmission instruction to, for example, the power supply unit D according to the expectation value table 16b (step T41). In the power supply unit D, the power line communication unit 34 transmits identification information D according to the identification information transmission instruction. The identification information D is transmitted to the terminal 22 of the power supply device Y via the power line 2d, but not received by another power supply unit 3 since no other power line is connected to the terminal 22 (step T42). In the power supply redundancy monitoring unit 10, no notification of the reception information is given from the power supply unit that has received the identification information D, and the standby period of time by the identification information transmission processing unit 12 elapses.

When transmission of the identification information by all the power supply units 3 is completed, the state determining unit 14 (the comparing unit 14a and the detecting unit 14b) determines the connection state between the power supply unit 3 and the power supply device 2 based on the expectation value table 16b and the reception table 16c, and generates the power connection information 16e (step T43). Then, the output unit 15 causes the power connection information 16e to be stored and displayed on an output device or the like (step T44), and then the process of the power supply redundancy monitoring unit 10 is completed.

As described above, according to the information processing device 1 (the information processing device 1a and the information processing device 1b) illustrated in FIGS. 1 and 4, the comparing unit 14a compares the expectation value (the expectation value table 16b) with the connection information (the reception table 16c). Further, the detecting unit 14b detects an incorrect connection between the power supply device X and the power supply units A and B based on the comparison result or detects an incorrect connection between the power supply device Y and the power supply units C and D. Thus, in the information processing device 1 connected to a plurality of power supply devices 2, it is possible to detect an incorrect connection between the power supply device 2 and the power supply unit 3. Thus, for example, since the operator or the like can check the connection state and correct the connection, it is possible to prevent an incorrect connection between the power supply device 2 and the power supply unit 3 and improve reliability of the information processing device 1.

Further, even when the information processing device 1 being operated and another information processing device 1′ being operated are connected with the power supply device 2 as illustrated in FIG. 8, it is possible to check the redundancy of the power supply unit 3 by the information processing device 1 without stopping the operation of another information processing device 1′. Thus, even when the power supply unit 3 having the redundancy configuration is erroneously connected with the power supply device 2, it is possible to detect abnormality while maintaining the normal operation of the overall system.

Further, when the first information and the second information are transmitted from the power supply unit 3 to the power supply device 2, the expectation value is information representing power supply unit 3 that receives the first information and the second information through the power supply device 2, and the connection information is information representing the power supply unit 3 that has received the first information and the second information transmitted from the power supply unit 3 through the power supply device 2. As described above, the information processing device 1 transmits and receives the identification information of each power supply unit 3, and compares the expectation value with the actual reception result, and thus it is possible to check the connection state between the power supply device 2 and the power supply unit 3 and detect an incorrect connection with a high degree of accuracy.

Furthermore, according to the identification information transmission processing unit 12, the identification information reception processing unit 13, and the power line communication units 31 to 34, the identification information is transmitted and received (notified) through the power line actually connected between the power supply device 2 and the power supply unit 3, and thus it is possible to detect the connection state between the power supply device 2 and the power supply unit 3 with a high degree of accuracy.

### [2] Others

The exemplary embodiments of the present invention have been described above, but the present invention is not limited to a certain relevant embodiment, and various modifications or changes can be made within the scope not departing from the gist of the present invention.

For example, the above embodiments have been described in connection with the example in which the number of power supply devices 2 is two or the number of power supply units 3 is two (see FIG. 1) or four (see FIG. 4), but the present invention is not limited to this example.

Further, the state determining unit 14 (the detecting unit 14b) may perform weighting, for example, according to “Δ” or “x” representing a mismatch based on the power connection information 16e and then decide the power supply unit 3 having the most improper connections (mismatches) after the weighting.

Furthermore, all or some of the functions of the information processing device 1 (the information processing device 1a or the information processing device 1b) according to the present embodiment including the power supply redundancy monitoring unit 10 (the generating unit 11, the identification information transmission processing unit 12, the identification information reception processing unit 13, the state determining unit 14 (the comparing unit 14a and the detecting unit 14b), and the output unit 15 are implemented by executing a certain program through a computer (including a CPU, an information processing device, or various terminals).

For example, the program is provided in a form recorded in a computer readable recording medium such as a flexible disk, a CD (a CD-ROM, a CD-R, a CD-RW, or the like), a DVD (a DVD-ROM, a DVD-RAM, a DVD-R, a DVD-RW, a DVD+R, a DVD+RW, or the like), or a blu ray disk. In this case, a computer reads the program from the recording medium, transfers the read program to an internal storage device or an external storage device, and then uses the program.

Here, the computer is a concept including hardware and an operating system (OS), and means hardware operating under control of the OS. Further, when an OS is unnecessary and hardware is operated by an application program itself, the hardware corresponds to the computer. The hardware includes at least a micro-processor such as a CPU and a device that reads a computer program recorded in a recording medium. The program includes a program code causing the computer to execute various kinds of functions of the information processing device 1 according to the present embodiment. Further, some of the functions may be implemented by an OS other than an application program.

The object of the present disclosure is not limited to the above objects, and an operational effect that is derived by each component described in an exemplary embodiment for carrying out the invention but not derived by a related art can be obtained as another object of the present disclosure.

According to the embodiment, it is possible to detect an incorrect connection between a power supply device and a power supply unit of an information processing device.

All examples and conditional language provided herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device that is supplied with electric power from a first power supply device or a second power supply device, the information processing device comprising:
a first power supply unit that is connected to the first power supply device;
a second power supply unit that is connected to the second power supply device;
a storage unit that stores a first expectation value indicating a state in which the first power supply device is connected with the first power supply unit and a second expectation value indicating a state in which the second power supply device is connected with the second power supply unit; and
a processor,
wherein the processor
acquires first connection information indicating a connection state between the first power supply unit and the first power supply device and second connection information indicating a connection state between the second power supply unit and the second power supply device;
compares the first expectation value with the first connection information and compares the second expectation value with the second connection information; and
detects an incorrect connection between the first power supply device and the first power supply unit or an incorrect connection between the second power supply device and the second power supply unit based on a comparison result obtained by the comparing.

2. The information processing device according to claim 1,
wherein the first expectation value is information representing a power supply unit that receives first information through the first power supply device when the first information is transmitted from the first power supply unit to the first power supply device, and the first connection information is information representing a power supply unit that receives the first information transmitted from the first power supply unit through the first power supply device, and
the second expectation value is information representing a power supply unit that receives second information through the second power supply device when the second information is transmitted from the second power supply unit to the second power supply device, and the second connection information is information representing a power supply unit that receives the second information transmitted from the second power supply unit through the second power supply device.

3. The information processing device according to claim 2,
wherein the first information is first identification information representing the first power supply unit, and the second information is second identification information representing the second power supply unit, and
wherein the processor
causes the first power supply unit to transmit the first identification information to the first power supply device, and causes the second power supply unit to transmit the second identification information to the second power supply device; and
acquires the first connection information and the second connection information based on the first identification information or the second identification information received through the first power supply device or the second power supply device through the first power supply unit and the second power supply unit.

4. The information processing device according to claim 2,
wherein each of the first power supply unit and the second power supply unit comprises a communication unit that transmits the first information or the second information to a power supply device connected via a power line, and receives the first information or the second information from the power supply device via the power line.

5. The information processing device according to claim 2,
wherein the processor generates the first expectation value and the second expectation value based on power information representing a connection relation of the first power supply unit, the second power supply unit, the first power supply device, and the second power supply device, stores the first expectation value and the second expectation value in the storage unit, and generates the first information and the second information.

6. An improper connection detection method for a power supply in an information processing device that is supplied with electric power from a first power supply device or a second power supply device and includes a first power supply unit connected to the first power supply device and a second power supply unit connected to the second power supply device, the improper connection detection method comprising:
acquiring first connection information indicating a connection state between the first power supply unit and the first power supply device and second connection information indicating a connection state between the second power supply unit and the second power supply device;
comparing a first expectation value that is stored in a storage unit and indicates a state in which the first power supply device is connected with the first power supply unit with the acquired first connection information, and comparing a second expectation value that is stored in the storage unit and indicates a state in which the second power supply device is connected with the second power supply unit with the acquired second connection information; and
detecting an incorrect connection between the first power supply device and the first power supply unit or an incorrect connection between the second power supply device and the second power supply unit based on a comparison result.

7. The improper connection detection method according to claim 6,
wherein the first expectation value is information representing a power supply unit that receives first information through the first power supply device when the first information is transmitted from the first power supply unit to the first power supply device, and the first connection information is information representing a power supply unit that receives the first information transmitted from the first power supply unit through the first power supply device, and
the second expectation value is information representing a power supply unit that receives second information through the second power supply device when the second information is transmitted from the second power supply unit to the second power supply device, and the second connection information is information representing a power supply unit that receives the second information transmitted from the second power supply unit through the second power supply device.

8. The improper connection detection method according to claim 7,
wherein the first information is first identification information representing the first power supply unit, and the second information is second identification information representing the second power supply unit,
the improper connection detection method further comprises causing the first power supply unit to transmit the first identification information to the first power supply device and causing the second power supply unit to transmit the second identification information to the second power supply device, and
wherein the acquiring process includes acquiring the first connection information and the second connection information based on the first identification information or the second identification information received through the first power supply device or the second power supply device through the first power supply unit and the second power supply unit.

9. The improper connection detection method according to claim 7, further comprising
transmitting the first information or the second information to a power supply device connected via a power line and receiving the first information or the second information from the power supply device via the power line in the first power supply unit and the second power supply unit.

10. The improper connection detection method according to claim 7, further comprising
generating the first expectation value and the second expectation value based on power information representing a connection relation of the first power supply unit, the second power supply unit, the first power supply device, and the second power supply device, storing the first expectation value and the second expectation value in the storage unit, and generating the first information and the second information.

11. A computer-readable recording medium having stored therein an improper connection detection program for a power supply for causing a computer that is supplied with electric power from a first power supply device or a second power supply device and includes a first power supply unit connected to the first power supply device and a second power supply unit connected to the second power supply device, to execute a process for detecting the improper connection, the process comprising:
acquiring first connection information indicating a connection state between the first power supply unit and the first power supply device and second connection information indicating a connection state between the second power supply unit and the second power supply device;
comparing a first expectation value that is stored in a storage unit and indicates a state in which the first power supply device is connected with the first power supply unit with the acquired first connection information, and comparing a second expectation value that is stored in the storage unit and indicates a state in which the second power supply device is connected with the second power supply unit with the acquired second connection information; and
detecting an incorrect connection between the first power supply device and the first power supply unit or an incorrect connection between the second power supply device and the second power supply unit based on a comparison result.

12. The computer-readable recording medium according to claim 11,
wherein the first expectation value is information representing a power supply unit that receives first information through the first power supply device when the first information is transmitted from the first power supply unit to the first power supply device, and the first connection information is information representing a power supply unit that receives the first information transmitted from the first power supply unit through the first power supply device, and
the second expectation value is information representing a power supply unit that receives second information through the second power supply device when the second information is transmitted from the second power supply unit to the second power supply device, and the second connection information is information representing a power supply unit that receives the second information transmitted from the second power supply unit through the second power supply device.

13. The computer-readable recording medium according to claim 12,
wherein the first information is first identification information representing the first power supply unit, and the second information is second identification information representing the second power supply unit,
the process further comprises causing the first power supply unit to transmit the first identification information to the first power supply device and causing the second power supply unit to transmit the second identification information to the second power supply device, and
wherein the acquiring includes acquiring the first connection information and the second connection information based on the first identification information or the second identification information received through the first power supply device or the second power supply device through the first power supply unit and the second power supply unit.

14. The computer-readable recording medium according to claim 12,
wherein the process further comprises transmitting the first information or the second information to a power supply device connected via a power line and receiving the first information or the second information from the power supply device via the power line in the first power supply unit and the second power supply unit.

15. The computer-readable recording medium according to claim 12,
wherein the process further comprises generating the first expectation value and the second expectation value based on power information representing a connection relation of the first power supply unit, the second power supply unit, the first power supply device, and the second power supply device, storing the first expectation value and the second expectation value in the storage unit, and generating the first information and the second information.
